(19) United States
(12) Patent Application Publication
(10) Pub. No.: US 2026/0111620 A1
(43) Pub. Date: Apr. 23, 2026

(54) BUILD-ANGLE FILTERING DURING SYNTHESIZING OF THREE-DIMENSIONAL MODELS OF PHYSICAL OBJECTS FOR ADDITIVE MANUFACTURING PROCESSES

(71) Applicant: Autodesk, Inc., San Francisco, CA (US)

(72) Inventor: Benjamin McKittrick Weiss, Tualatin, OR (US)

(21) Appl. No.: 19/012,741

(22) Filed: Jan. 7, 2025

Related U.S. Application Data
(60) Provisional application No. 63/709,078, filed on Oct. 18, 2024.

(51) Int. Cl. G06F 30/17; B29C 64/386; B33Y 50/00; G06F 113/10

(52) U.S. Cl. CPC G06F 30/17; B29C 64/386; B33Y 50/00; G06F 2113/10

(57) ABSTRACT

Methods, systems, and apparatus, including medium-encoded computer program products, for computer aided design of physical structures using three-dimensional model synthesis processes. A method includes: obtaining a build angle, a manufacturing direction, a design space, and one or more design criteria for use in a shape synthesis process, the build angle and the manufacturing direction being for an additive manufacturing process; performing the shape synthesis process including applying a build-angle filter to a boundary-based computer-data representation of an intermediate version of the shape of the modeled object during multiple iterations, including removing a portion of material from the intermediate version of the shape in accordance with the build angle and the manufacturing direction to make the intermediate version of the shape self-supporting in a vicinity of the portion of material; and providing the shape of the modeled object for use in manufacturing using the additive manufacturing process.

### CROSS-REFERENCE TO RELATED APPLICATIONS

This application claims the benefit of priority of U.S. Patent Application No. 63/709,078, entitled “BUILD-ANGLE FILTERING DURING SYNTHESIZING OF THREE-DIMENSIONAL MODELS OF PHYSICAL OBJECTS FOR ADDITIVE MANUFACTURING PROCESSES”, filed Oct. 18, 2024.

### BACKGROUND

### Technical Field

This specification relates to computer aided design of physical structures, which can be manufactured using additive manufacturing processes.

### Description of Related Art

In the design and manufacturing industry in which this innovation has its primary relevance, Computer Aided Design (CAD) software is used to generate three-dimensional (3D) representations of objects, while Computer Aided Manufacturing (CAM) software is used to prepare, evaluate, plan, and control the manufacture of those objects, e.g., using a 3D printer or other additive manufacturing techniques.

CAD software has been designed to perform automatic generation of 3D geometry of one or more parts in a design (known as “topology optimization”, “generative design”, or “generative modelling”, and more recently AI-enhanced shape synthesis tools). This automated generation of 3D geometry often works within a “design domain” specified by a user or the CAD software and generates geometry typically by optimizing design objectives and respecting design constraints, which can be defined by the user, the CAD software, or a third party. Design objectives can include minimizing waste material, minimizing the weight of the part, and minimizing the compliance, stress, or other intrinsic property of the part, and are used to drive the shape synthesis process towards better designs. Though not required, it is typical for a design objective to be rooted in a simulation of the design, e.g., linear static, fluid dynamic, electromagnetic, etc. Design constraints can include a variety of physical characteristics or behaviors that must be met in any generated design (requirements either on individual parts or on the entire assembly are also admissible); examples include maximum mass, maximum deflection under load, maximum stress, etc. Geometric constraints may also be provided, for example to ensure the generated shape has no tiny features or is more easily built using a particular manufacturing process.

Further, the geometric inputs to such a 3D geometry generation tool can include one or more user- or CAD system-provided “preserves” which are surfaces or bodies which should always be present in the design, and which represent interfaces to other parts of the systems or locations on which boundary conditions should be applied (for example mechanical loads and constraints). Other regions in which geometry should or should not be generated can also be provided in a similar manner (referred to as “obstacle bodies”). Often, the shape synthesis process takes place using a different representation of geometry than that employed by the CAD system. For example, a CAD system might use a boundary representation (“B-Rep”) while the geometry generation engine might employ a level set function embedded in a voxel or tetrahedral mesh.

“Casting” and “molding” cover a range of manufacturing processes that create parts by solidifying molten (or quasi-molten) feedstock inside the cavity of a mold (often composed of two or more pieces held together). Once the feedstock has solidified, the mold is removed to reveal the final part. Casting processes support a variety of feedstock materials, including metals, plastics, and ceramics, and different processes leverage different configurations of the mold and feedstock material.

In some casting and molding processes (such as injection molding), the mold is arranged into two halves which meet at a “parting surface”, which can be a plane or non-planar surface. The mold is removed from the manufactured part at the end of the process by drawing the two mold halves away from each other along a specified “ejection direction” or “draw direction”. It is a design requirement for parts manufactured using processes like this that the two halves of the mold must be able to be removed without interfering with the final part. This constraint is satisfied by ensuring no “overhanging” or “enclosed” regions of the part would cause the mold to interlock with the final part, and that vertical surfaces are drafted (slanted) such that they allow the mold to be cleanly removed without introducing friction.

In other casting and molding processes (such as sand casting), the mold is created from a low cost material such as sand and is destroyed at the end of the process. The creation of the mold is performed using a casting-like preprocess in which a designed part is split along the parting surface and used to form sand or another mold material into two half-molds which are fused together to form the final mold. In this case, the design constraint comes from the need to remove the designed part from the mold halves during mold construction and must meet the same overhang and draft constraints described above.

More generally, additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Casting and forging (both hot and cold) and molding can be grouped with additive manufacturing processes in that the manufactured objects are built in 3D by the addition of raw materials, rather than by removal (or subtraction) of material from a starting “blank” or workpiece, as in Computer Numerical Control (CNC) milling.

### SUMMARY

This specification describes technologies relating to computer aided design of physical structures, which can be manufactured using additive manufacturing processes, such as FFF (or another additive extrusion or deposition manufacturing process).

The described systems and techniques allow automatic design of parts/components using a constraint that takes into account a build-angle requirement associated with an additive manufacturing process, which is to be used to manufacture the components, thus reducing the complexity and costs of manufacturing parts/components (the physical structure) that have been algorithmically designed (at least in part). Build-angle filtering can be performed by a computer during a shape synthesis process (such as inside an iterative loop of topology optimization) to ensure the design of the modelled object is self-supporting where this is possible, and also to minimize overhangs in regions where self-support is not possible or desirable, thus minimizing the amount of external support material needed to manufacture the physical structure (e.g., using an additive extrusion/deposition manufacturing method that has an associated overhang angle limitation). In some implementations, the build angle is a draft angle for casting, forging or molding (rather than an overhang angle) and the build-angle filtering can eliminate vertical walls in the design that cause undue friction during part removal, e.g., friction with the mold is reduced so the mold can be removed from the manufactured part. In some implementations for enforcing a draft angle for manufacturing, application of the build-angle filter also removes undercuts from the design (the modelled object) of the physical structure. The build-angle filtering process can be implemented in the context of generative design, automated modeling, or any of a variety of other shape synthesis algorithms.

Various embodiments of the subject matter described in this specification can be implemented to realize one or more of the following advantages. Overhanging regions of a design can be reduced overall, and also be fully eliminated where possible in the design, as identified by the algorithm, including in regions that are “interior” to the design, i.e., an overhang that would require an external support structure that either extends from the overhang down to another part of the physical structure, or extends from the overhang in a slanted or curved manner to avoid the other part of the physical structure and touch down on the build plate. Reducing or eliminating such external support structures, which would otherwise be required to manufacture the physical structure, significantly reduces the labor required to remove external support structures after manufacturing of the physical structure, and avoids reduction of surface quality that can result when such external support structures are removed. By minimizing (and in some cases eliminating) the regions of the design that will require external support structures to manufacture the physical object, in the course of the automated design of that physical object's design, the amount of support material (and associated post-processing work) needed to produce the physical object using additive manufacturing is reduced.

The build-angle filter ensures that regions of the design that can be self-supporting are made to be self-supporting; in remaining regions where there is no plausible way to make the design self-supporting (i.e., requiring full self-support would overbuild the structure to accommodate the manufacturing process, which can result in mechanical performance degradation) the design can still be made more self-supporting, thus reducing the use of external support structures in these other regions of the design as well. Thus, the described systems and techniques can synthesize shapes for modeled objects that make those objects more (or fully) self-supporting during additive manufacturing, reducing or eliminating the external support structures needed for manufacturing. This results in reduced material waste during additive manufacturing, reduced time for manufacturing the finished physical structure, and reduced post-processing effort associated with conventional approaches to supporting automatically designed parts and thus enhances the quality of the additively manufactured parts.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to perform build-angle filtering to produce physical structures with designs that are tailored to facilitate manufacturing using an additive manufacturing processes.

FIG. 2 shows an example of a process employing build-angle filtering during shape synthesis to produce physical structures with designs that are tailored to facilitate manufacturing using an additive manufacturing processes.

FIG. 3A shows an example of an iterative loop shape synthesis process that varies the shape of a computer model and applies a build-angle filter.

FIG. 3B shows an example of interaction between shape and/or topology optimization and application of a build-angle filter.

FIG. 3C shows an example of a process of velocity filtering.

FIG. 3D shows a schematic representation for a velocity filter update.

FIG. 4A shows an example of a process that implements a build-angle filter.

FIG. 4B shows an example of a 3D model as that 3D model is modified by the process of FIG. 4A.

FIG. 5A shows an example of a process for identifying and then removing portion(s) of an input shape that are not self-supported even though full-self support is possible in that region of the design space for the input shape.

FIG. 5B shows an example of unsupportable region removal using the 3D model of FIG. 4B.

FIG. 5C shows an example of void shape generation and subtraction from an input shape.

FIG. 6 shows another example of a process for identifying and then removing portion(s) of an input shape that are not self-supported even though full-self support is possible in that region of the design space for the input shape.

FIG. 7 shows yet another example of a process for identifying and then removing portion(s) of an input shape that are not self-supported even though full-self support is possible in that region of the design space for the input shape.

FIG. 8A shows an example of an input shape and its corrected shape after applying a geometry filter employing a signed distance field update rule.

FIG. 8B shows neighbor sampling for the signed distance field update rule.

FIG. 8C shows a schematic representation for the signed distance field update rule used to implement the geometry filter.

FIG. 8D shows examples of cusp geometry generation for two different input 3D shapes.

FIG. 9 is a schematic diagram of a data processing system including a data processing apparatus, which can be programmed as a client or as a server.

Like reference numbers and designations in the various drawings indicate like elements.

### DETAILED DESCRIPTION

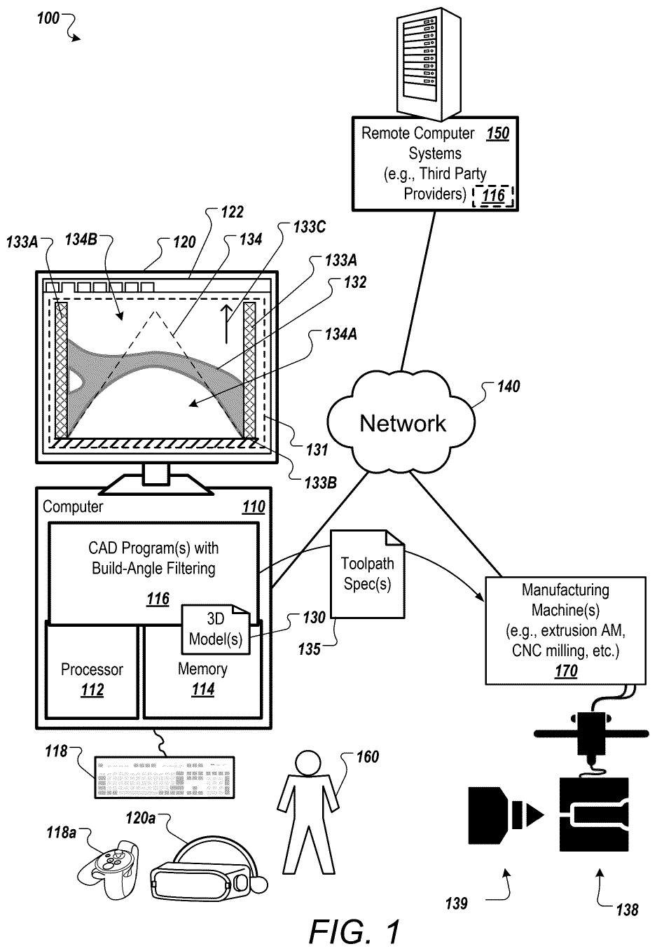

FIG. 1 shows an example of a system 100 usable to perform build-angle filtering, such as can be performed during shape synthesis, e.g., during generative design using one or more design criteria, to produce physical structures that are tailored to facilitate manufacturing using additive manufacturing processes. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which implement three-dimensional (3D) modeling functions and includes a build-angle filter for geometry of a three-dimensional model of a physical object, which can be employed in one or more automated design processes, e.g., topology optimization using at least one level-set method, with or without numerical simulation.

As used in this detailed description, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, CAD program(s) 116 can be two or more programs that operate cooperatively on two or more separate computer processors in that one or more programs operating locally at computer 110 can offload processing operations (e.g., generative design (or more generally, shape synthesis) and/or physical simulation operations) “to the cloud” by having one or more programs on one or more computers 150 perform the offloaded processing operations. In some implementations, all generative design (or more generally, shape synthesis) operations are run by one or more programs in the cloud and not in a shape representation modeler (e.g., B-Rep modeler) that runs on the local computer. Moreover, in some implementations, the generative design (or more generally, shape synthesis) program(s) can be run in the cloud from an Application Program Interface (API) that is called by a program, without user input through a graphical user interface.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 interacts with the CAD program(s) 116 to create and modify 3D model(s), which can be stored in 3D model document(s) 130. This can include initiating a shape synthesis process, which can take into account the planned manufacturing method by applying a build-angle filter during at least one or more intermediate iterations of a shape (and optionally topology) optimization loop. The build-angle filter can be applied by the CAD program(s) 116 in every iteration of the optimization loop, or in only some of the iterations of the loop, such as in several intermediate iterations early on in the optimization process, or only in later iterations after first allowing some free form modification of the three-dimensional shape of the modelled object. In any case, applying the build-angle filter can reduce or eliminate overhanging features, which will require external support structure, in the produced design.

The user 160 can specify a build angle and/or a manufacturing direction to be used by the CAD program(s) 116 when synthesizing a three-dimensional (3D) shape of a 3D model 132. In some cases, the build angle and/or the manufacturing direction can be selected by the CAD program(s) 116 based on knowledge of the manufacturing process and machine to be used to build the physical object, e.g., obtaining the build angle indirectly through the user's selection of a specific manufacturing process. In the case of casting, forging or molding, the user 160 can specify an ejection direction and/or a parting surface; note that a planar parting surface inherently specifies an ejection direction, and an ejection direction (along with a location along the ejection direction) can be used to specify a planar parting surface, since the ejection direction is normal to the planar parting surface. But the specified parting surface need not be planar. In some cases, the build angle and/or manufacturing direction can be intelligently guessed by the CAD program(s) 116, e.g., if not provided by the user 160.

In any case, a design space 131 is used by the CAD program(s) 116 to iteratively modify the 3D model 132, which represents a physical structure to be manufactured once the design is completed, in a shape synthesis process. In the example shown in FIG. 1, the 3D model 132 is generated between two preserve bodies 133A, in view of a build plate representation 133B for an additive manufacturing process that deposits material on a build plate in a build direction 133C (e.g., starting from the build plate, material is added in respectively higher layers to build the physical structure). The various build-angle filtering algorithms described in this application identify at least two distinct regions of the design domain 131 for the current shape (also referred to as the current design) of the 3D model 132: a first region 134A and a second region 134B, separated by a dividing surface 134 (shown as a dashed line in the figure, which represents 3D objects in 2D). This dividing surface 134 information is used during the shape synthesis in the iterative loop that changes the design of the 3D model 132 based on one or more design criteria.

In the first region 134A, it does not make sense to modify the design to create a fully self-supporting shape because doing so would require a new contact be made with the build plate representation 133B by the 3D model 132. Adding material/geometry to the physical structure (being designed) in the first region 134A merely to make the design self supporting means the part is being overdesigned for the manufacturing plan, e.g., such added material are unlikely to improve the mechanical properties of the part. Thus, one might as well use external support structure(s) in this region in order to manufacture the part.

In contrast, the second region 134B has existing design geometry (found in the current 3D model 132, in the preserve bodies 133A, or both) that can be used to provide self-support for the physical structure (during manufacturing). Thus, in the second region 134B, the current design is required (by the disclosed algorithms) to be self-supporting, e.g., with all overhanging faces having angles less than the overhang angle associated with the additive manufacturing process. Further, this fully self-supporting requirement is effected by removing material from the current design (i.e., from the 3D model 132) that is located in the second region 134B but is not currently self-supported by the current design.

This removal of unsupported portions of the design, in a region where full self-support is possible for the design, enables full enforcement of the self-supporting design constraint in the second region 134B by undoing the addition (by the shape synthesis process) of any non-self-supported material in the second region 134B where full self-support has been determined to be possible for the current design. In contrast, since full self-support is not possible in the first region 134A (without adding undesirable connection(s) between the 3D model 132 and the build plate) the shape is allowed to evolve in the first region 134A in a more unrestricted manner, potentially with the use of a geometry filter to add material to the 3D model 132 in the first region 134A to make the 3D model 132 more self-supported in the first region 134A, even when not made fully self-supporting, as described in further detail below.

In any case, the 3D model 132 that is produce can be stored as 3D model document(s) 130 and/or used to generate another representation of the model (e.g., toolpath specifications for a manufacturing process). This can be done upon request by the user 160, or in light of the user's request for another action, such as sending the automatically generated 3D model 132 to a manufacturing machine 170, which can be directly connected to the computer 110, or connected via a network 140, as shown. This can involve a post-process carried out on the local computer 110 or externally, for example, based on invoking a cloud service running in the cloud, to further process the generated 3D model (e.g., based on considerations associated with the manufacturing process) and to export the 3D model to an electronic document from which to manufacture.

Note that an electronic document (which for brevity will simply be referred to as a document) can be a file, but does not necessarily correspond to a file. A document may be stored in a portion of a file that holds other documents, in a single file dedicated to the document in question, or in multiple coordinated files. In addition, the user 160 can save or transmit the 3D model for later use. For example, the CAD program(s) 116 can store the 3D model document(s) 130 that includes the generated 3D model.

Also note that the 3D model 132 represents the part to be manufactured using an additive manufacturing process, such as additive extrusion manufacturing (e.g., FFF or metal deposition) or casting, forging or molding. In some cases, the manufacturing machine 170 builds the physical structure directly, and in some cases, the manufacturing machine 170 builds a mold for use in casting, forging or molding the physical structure. Thus, the toolpath specifications that are generated can be for use in constructing a mold that is then used to manufacture the physical structure corresponding to the 3D model, such as mold cavity 138 to be used with injection unit 139. As will be appreciated, different types of casting or molding manufacturing processes can be employed, such as die casting, sand casting, permanent mold casting, compression molding, extrusion molding, and injection molding.

The manufacturing machine 170 can be one or more manufacturing machines, including a Computer Numerical Control (CNC) milling machine, such as a multi-axis, multi-tool milling machine (for subtractive manufacturing operations) and/or an extrusion-based additive manufacturing machine (e.g., a CNC metal deposition machine). Thus, the toolpath specifications that are generated can be for use in constructing the physical structure directly. In any case, the CAD program(s) 116 can provide a document 135 (having toolpath specifications of an appropriate format) to the manufacturing machine 170 to manufacture the physical structure directly, where that physical structure has a 3D topology and/or shape that facilitates the manufacturing by having no overhangs that violate the overhang angle for the material and machine being used, or to create at least a mold cavity from stock material, where the shape of the physical structure to be manufactured with that mold cavity includes the optimized topology and/or shape that facilitates the casting or molding manufacturing process by having no walls that are steeper than the draft angle for the material and machine being used.

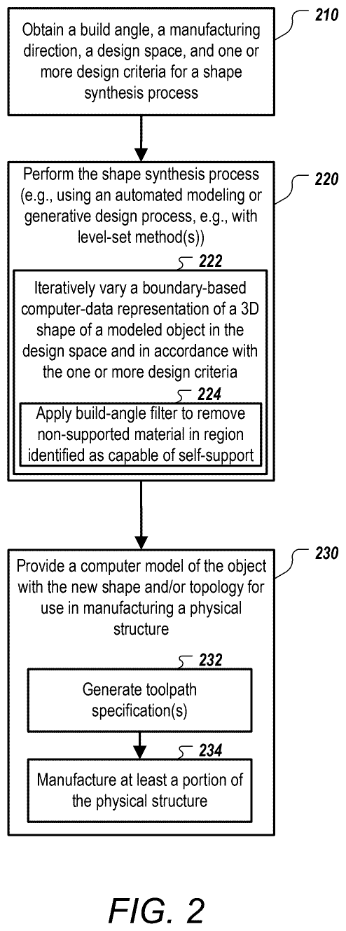

FIG. 2 shows an example of a process employing build-angle filtering during shape synthesis to produce physical structures with designs that are tailored to facilitate manufacturing using an additive manufacturing processes. A build angle, a manufacturing direction, a design space, and one or more design criteria for a shape synthesis process are obtained 210, e.g., by CAD program(s) 116 or 3D modeling program(s) 904. As noted above, the build angle can be an overhang angle for additive extrusion/deposition manufacturing or a draft angle for casting, forging or molding manufacturing, and so the manufacturing direction can be a build direction (for additive extrusion/deposition manufacturing) or an ejection direction (for casting, forging or molding manufacturing). Moreover, the build angle and the manufacturing direction need not be fixed. For example, an additive extrusion/deposition manufacturing system can include a holder for the workpiece that provides at least one axis of rotation (e.g., FFF on a spinning cylindrical build plate) which provides the ability to select and/or change the build direction, including during the manufacture of a single object. As another example, the build angle for an additive extrusion/deposition manufacturing system can be selected and/or changed by using extrusion materials with different viscosities. In any case, the build angle and the manufacturing direction are for the additive manufacturing process that will be used to manufacture the physical structure represented by the 3D model that is automatically designed by the shape synthesis process.

The shape synthesis process can be a structural generative design process that has associated boundary conditions, e.g., boundary conditions associated with mechanical loads such as force, moment, pressure, etc., and mechanical constraints such as fixed, bearing, pin, etc., which can specify in-use load case(s) of the physical structure. Other types of automated design processes can be employed. Nonetheless, the shape synthesis process employs a boundary-based approach, where a boundary-based computer-data representation of a three-dimensional shape of the modeled object is used, rather than a density-based approach, such as a Solid Isotropic Material with Penalization (SIMP) method. In some implementations, the boundary-based computer-data representation is a level-set computer-data representation; note that the shape synthesis process can use a level-set topology optimization method.

Moreover, one or more signed distance field (SDF) representations can be used, as described further below. Thus, the level-set computer-data representation can include a data structure including discrete elements (e.g., voxel or tetrahedral mesh elements) holding data values indicating distances to an implicit surface of the three-dimensional shape of the modeled object. Note that other boundary-based computer-data representations can be used, such as a neural net (NN) representation, which can encode an internal representation of a level set function implicitly in their neural network weights, rather than store and/or sample the level set in a regular grid (e.g., a voxel or tetrahedral mesh). In such implementations, the shape can be “read” out of the NN by repeatedly giving the NN a point location (not necessarily aligned with a voxel) and reading the NN response of the corresponding level set value.

The one or more design criteria can include design objective(s) and design constraint(s) for the object. Design objectives can include but are not limited to minimizing waste material, minimizing the weight of the part, and minimizing the compliance, stress, or other intrinsic property of the part, and are used to drive the shape synthesis process towards better designs. Though not required, it is typical for a design objective to be rooted in a simulation of the design, e.g., linear static, fluid dynamic, electromagnetic, etc. Design constraints can include a variety of geometric and physical characteristics or behaviors that should be met in any generated design (requirements either on individual parts or on the entire assembly are also admissible); examples include maximum mass, maximum deflection under load, maximum stress, etc.

The one or more design criteria can also include geometric objectives for the shapes and geometric constraints. The geometric constraints can be provided by a user or from the CAD program(s) 116 to ensure certain characteristics of the shape are realized, e.g., to provide a shape that is easier to manufacture. The input geometry can include details for preserve regions that should be present in the design as representing interfaces to other parts of the system or identify locations on which boundary conditions should be applied (e.g., mechanical loads and constraints).

The one or more design criteria can include one or more in-use load cases (e.g., one or more boundary conditions that specify one or more in-use load cases) for the physical structure to be manufactured from the automatically designed part. The one or more in-use load cases can be associated with a setup for numerical simulation, e.g., densities of elements in an FEA model to be used with an optimized 3D topology of the part being automatically designed. However, as used herein, “in-use load cases” refer generally to separate groups of loads and constraints under which part performance is evaluated and correspond to sets of boundary conditions for various types of physics simulations, such as fluid flow simulation, electro-magnetic (EM) behavior simulation, multi-physics simulation, etc. Thus, various types of boundary conditions, e.g., pressure and/or velocity boundary conditions, can be used.

In general, the setup for numerical simulation can include one or more physical properties to be simulated and one or more types of simulation to be performed, as well as potentially surrogate modelling or other methods of approximation. In some implementations, the type of numerical simulation is predefined, either for all uses of the program or given a particular context in the program from which the shape synthesis process has been launched. Further, the setup for numerical simulation can include at least one set of loading conditions and/or other physical environment information associated with the type of numerical simulation to be performed.

Further, the design space can be obtained by determining a bounding volume or a convex hull for an input model, or another technique can be used to obtain the design space, which is the volume of space inside which the part is to be designed during shape and/or topology optimization. In some cases, the user may explicitly specify the design space. In some implementations, the user may define a topology optimization problem for a generative design process to produce a desired 3D model from a starting 3D model, or the input can be a design space without a specific starting 3D model. In general, the input design space can be automatically generated or user specified. Note that the shape synthesis process itself can produce starting geometry within the design space. For example, one or more seed models can be used as input to the shape synthesis process to introduce holes at the start of the shape evolution so as to modify the topology of the 3D model.

The design space for the modeled object is the volume inside which the part is to be designed. The design space can include a bounding volume containing an initial specification of one or more outer shapes of the 3D topology for the object. The design space can include 3D model(s), designed in or loaded into the CAD program(s) 116, that serve as a sub-space of an optimization domain of a described generative design process, and/or a set of input regions, e.g., preserve bodies and/or surfaces, used to specify boundary conditions for generative design geometry production, e.g., B-Reps (or faces thereof) selected by a user through a user interface, such as the UI 122, to specify sub-region(s) that are preserved for use as connection point(s) with other component(s) in a larger 3D model or separate 3D model(s).

The shape synthesis process is performed 220, e.g., by CAD program(s) 116 or 3D modeling program(s) 904. This can be done using an automated modeling process (without boundary conditions) or using a generative design process (with one or more boundary conditions), and in some implementations, one or more level-set methods are used during the shape synthesis process. In the context of level set topology optimization, the shape synthesis process begins with a starting shape or “seed geometry” (either provided by the user or generated by an algorithm, such as the convex hull of the preserves) which is modified through successive iterations of an optimization loop to produce an “optimized design” or “final outcome” which minimizes some quantity of interest (e.g., strain energy) subject to some constraints (e.g., mass, max stress, and manufacturability). The optimization loop (in this example) involves numerical simulation, shape optimization, and advection. The numerical simulation performs a physics simulation of the current shape (e.g., compute strain energy everywhere inside the volume). The shape optimization transforms the result of the physics simulation (e.g., the strain energy field inside the volume) into a velocity field on the surface of the volume, where evolving the shape according to the velocity at each point moves the geometry towards a more optimal shape. Then, the advection updates the shape by moving each piece of the boundary according to its velocity. These three operations then repeat in a loop until the shape stops changing, or another exit condition is reached.

Shapes can be represented alternately by a grid of cubic voxels (for simulation), an implicit shape (for shape update) and optionally a polygonal mesh (for export, though a level set can be used for export as well). Shapes typically stay within a fixed design domain (also referred to as the design space) throughout the optimization process. Any user-specified regions of the design domain, called preserve bodies, are required to remain filled with material throughout the optimization process and can be used to specify boundary conditions on the physics problem (loads and constraints in solid mechanics, for example) as noted above. In the context of shape synthesis, the build-angle filter can be applied immediately after the advection operation, thus making the shape compatible with a build angle (relative to a manufacturing direction) for an additive manufacturing process (e.g., an overhang angle for additive extrusion/deposition manufacturing or a draft angle for casting, forging or molding manufacturing) at the end of each iteration of the loop in which the build-angle filter is applied.

Thus, performing the shape synthesis process includes iteratively varying 222, e.g., by CAD program(s) 116 or 3D modeling program(s) 904, a boundary-based computer-data representation of the 3D shape of the modeled object (in the design space) in accordance with the one or more design criteria to modify the three-dimensional shape of the modeled object. Further, the iteratively varying 222 includes applying 224, e.g., by CAD program(s) 116 or 3D modeling program(s) 904, a build-angle filter to remove non-supported material in a region identified as capable of self-support. The build-angle filter is applied 224 to the boundary-based computer-data representation of an intermediate version of the three-dimensional shape of the modeled object during two or more iterations of the iteratively varying 224. These iterations can be intermediate iterations of the loop, such as multiple loop iterations early on in the shape synthesis process, or multiple loop iterations performed later in the shape synthesis process after first allowing some free form modification of the three-dimensional shape of the modelled object.

This build-angle filter can be implemented using the geometry filter described below, but in general, the build-angle filter is configured to remove a portion of material from the intermediate version of the three-dimensional shape (in accordance with the build angle and the manufacturing direction) to make that intermediate version of the three-dimensional shape self-supporting in a vicinity of the portion of material, which is removed. This removed portion of material is that portion which is both not self-supported in the intermediate version of the three-dimensional shape and is located within a three-dimensional region of the design space identified as capable of being self-supported by the intermediate version of the three-dimensional shape, such as described in further detail below.

The result of the shape synthesis process can be presented to the user, e.g., in UI 122 on display device 120, along with an option to accept or reject the design. In some implementations, the user can select from a final design or any of a variety of previous iterations for each design study. In some implementations, two or more 3D models resulting from the shape synthesis process can be presented to the user along with trade-off analysis of design complexity versus cost of manufacturing, e.g., based on the amount of external support structure that will be needed, or any of a variety of other quantities of interest. The trade-off analysis can assist a user to accept or reject one or more 3D models among the presented 3D models that were automatically produced.

Once a design is not rejected, the 3D model of the object with the automatically designed shape and/or topology is provided 230, e.g., by CAD program(s) 116 or 3D modeling program(s) 904, for use in manufacturing a physical structure. The providing 230 can involve sending or saving the 3D model to a permanent storage device for use in manufacturing the physical structure corresponding to the object using one or more manufacturing systems. In some implementations, the providing 230 involves generating 232, e.g., by CAD program(s) 116 or 3D modeling program(s) 904, toolpath specifications for computer-controlled manufacturing system(s) using the 3D model, and manufacturing 234, e.g., by CAD program(s) 116 or 3D modeling program(s) 904, at least a portion of the physical structure corresponding to the object with the computer-controlled manufacturing system(s) using the generated 232 toolpath specifications.

In some implementations, the providing 230 can include manufacturing 234 at least a portion of a mold for a physical structure with the computer-controlled manufacturing system(s) using the generated 232 toolpath specifications, where the 3D model can be a model of the mold that will be manufactured using an additive and/or subtractive manufacturing process. In some implementations, the providing 230 can include manufacturing 234 at least a portion of a doppelganger of the physical structure, which is usable to form at least a portion of a mold for the physical structure, e.g., as in sand casting, using the generated 232 toolpath specifications. Note that it is not uncommon to create the mold parts by casting or molding mold material around the doppelganger, sometimes with additions to aid in the casting process such as vents and fill ports (which can be created digitally in the CAD model and manufactured with the doppelganger or manually by an operator as part of mold preparation). This approach can extend the doppelganger technique to other casting and molding processes.

The 3D model that is provided 230 can be the 3D model produced 220 by the shape synthesis process, or a post-processed version of the shape synthesis output. In some implementations, a polygon mesh, which can be extracted from the output from a boundary-based shape synthesis process, or shape design data obtained directly from the shape synthesis process, can be converted into a B-Rep model and/or a parametric feature model, e.g., by CAD program(s) 116 or 3D modeling program(s) 904. For example, the shape synthesis data can be level-set distance field data obtained directly from the boundary-based shape synthesis process. The B-Rep model or the parametric feature model can be editable as sketch geometry and parametric features. For example, in some implementations, a 3D mesh model produced by a generative design synthesis method can be converted into a watertight B-Rep 3D model, before being provided 230.

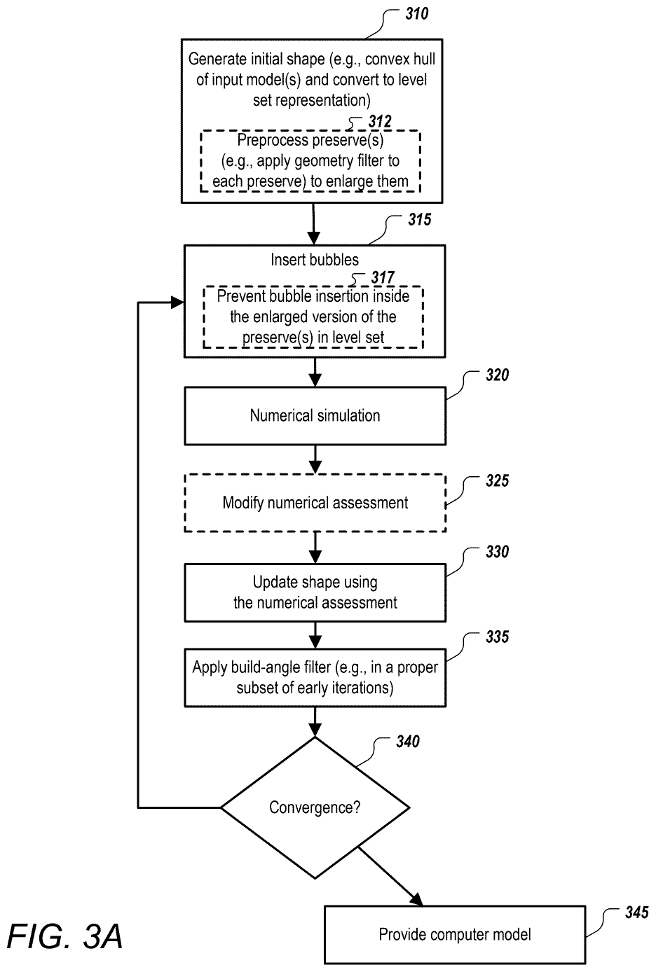

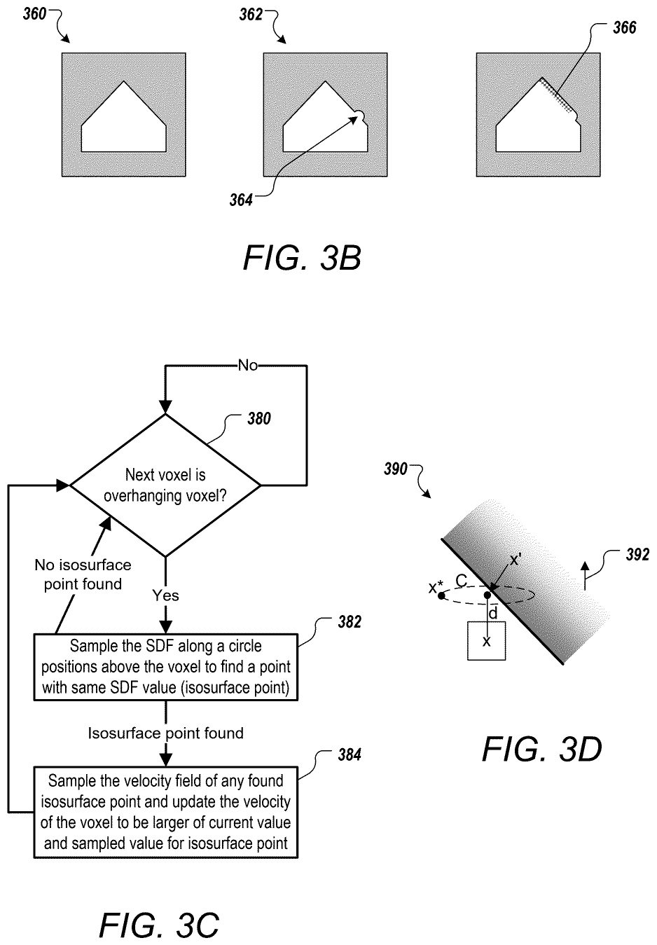

FIG. 3A shows an example of an iterative loop shape synthesis process that varies the shape of a computer model and applies a build-angle filter. An initial shape is generated 310, e.g., by CAD program(s) 116 or 3D modeling program(s) 904, as the starting shape for shape and/or topology optimization. As noted above, this can include generating a convex hull of any input preserves or otherwise using input to generate the initial shape. Further, the boundary-based computer-data representation used in the iterative loop can be a level-set computer-data representation.

Bubbles can be inserted 315, e.g., by CAD program(s) 116 or 3D modeling program(s) 904. This insertion of bubbles creates new voids inside the domain to allow the level set to evolve more freely, thus facilitating topology changes. This bubble insertion can occur in each iteration of the loop, as shown, or the bubble insertion can be limited to a proper subset of the iterations. In some implementations, no bubble insertion is performed.

Numerical simulation is performed 320, e.g., by CAD program(s) 116 or 3D modeling program(s) 904, for the modeled object in accordance with the one or more design criteria to produce a current numerical assessment of the modeled object. As noted above, the one or more design criteria can include boundary conditions that can define in-use load cases or other requirements (e.g., pressure and velocity boundary conditions, a geometric objective for topology evolution, etc.), and the current numerical assessment can be for the physical response (e.g., structural response) of the modeled object. Further, as noted above, various types of numerical simulation can be performed. For example, an FEA simulation can compute strain energy everywhere inside the volume of the current version of the 3D model. In any case, numerical simulation of the current 3D model produces a current numerical assessment that can then be used to change the shape and/or topology of the current 3D model in view of the one or more design criteria.

The 3D shape of the modeled object is updated 330, e.g., by CAD program(s) 116 or 3D modeling program(s) 904, using the numerical assessment to produce an updated version of the 3D shape. In some implementations, a level-set representation of an implicit surface of the modeled object is updated in accordance with shape change velocities computed for the implicit surface based on the current numerical assessment. For example, the strain energy field inside the volume (as determined by the numerical simulation) can be transformed into a velocity field on the surface of the volume, where the velocity at each point moves the geometry towards a more optimal shape, and the 3D shape can be advected to update the shape by moving each piece of the boundary according to its velocity.

The build-angle filter is applied 335, e.g., by CAD program(s) 116 or 3D modeling program(s) 904, such as in a proper subset of the early iterations and/or during later iterations of the loop to ensure the final shape is self-supporting where it can be. Further, in addition to removing unsupported material from the design in a region of the design space that has been identified as being capable of self-support for the current design, e.g., the second region 134B, application of the build-angle filter can also add material in another region of the design space, e.g., the first region 134A, in order to increase self-support in that other region, thus further reducing the amount of external support structures that will be needed to manufacture the physical structure. Further details and examples of the build-angle filter are provided below.

Before the loop continues, a check is made, e.g., by CAD program(s) 116 or 3D modeling program(s) 904, for convergence 340 to a final shape (note that the program code that performs the bubble insertion 315, numerical simulation 320, model update 330, and convergence 340 check can be referred to as the “optimizer”). This can be implicit convergence, as when the number of iterations corresponds to a predefined number of shape modification iterations to be completed, and/or when the modifications are no longer changing (or no longer significantly changing) the 3D shape and so further iterations will not improve the 3D model. Additionally, or alternatively, the convergence 340 check can be for explicit convergence by evaluating whether the current 3D model satisfies the one or more design criteria for the shape and/or topology optimization. If (implicit or explicit) convergence 340 has not been achieved, another iteration of the loop commences. Once (implicit or explicit) convergence 340 has been achieved, a computer model of the object is provided 345, e.g., by CAD program(s) 116 or 3D modeling program(s) 904, as output from the shape synthesis process, e.g., for use in manufacturing.

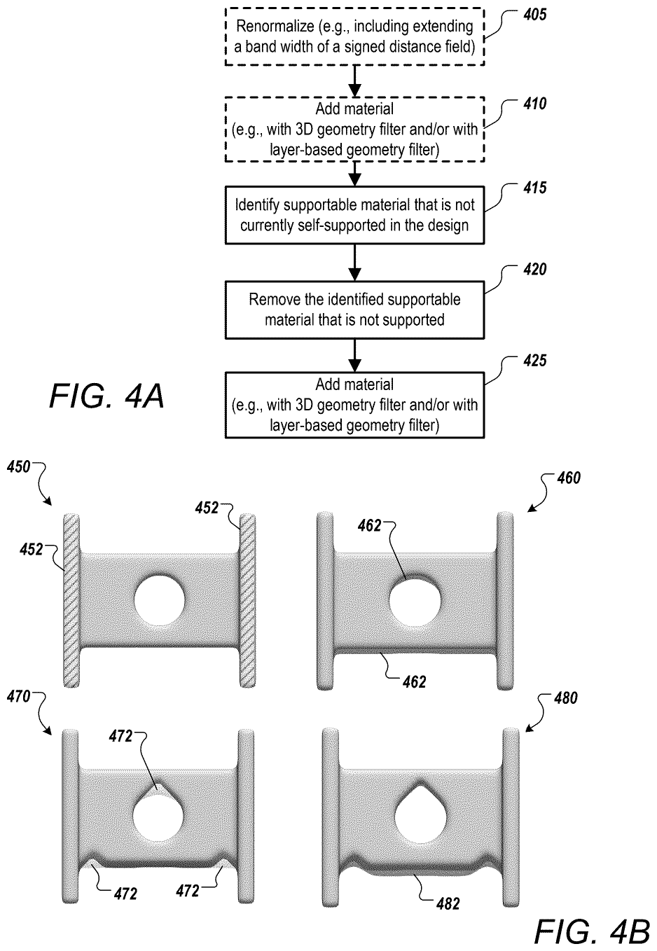

FIG. 4A shows an example of a process that implements a build-angle filter. The build-angle filter can convert an input shape (e.g., the result of a single iteration of a level set topology optimization code) into a nearest, plausibly self-supported equivalent shape (a “corrected shape”) by both adding and removing material from the input shape in view of the build angle and manufacturing direction. In some implementations, the build-angle filter generates the corrected shape, which represents a substantially (if not fully) self-supporting version of the input shape, using a signed distance field representation of the input shape (where a signed distance field is used as a level-set computer-data representation of the geometry of the modelled object), in three stages: (1) a preprocessing stage, (2) an unsupported region(s) removal stage, and (3) a region(s) tapering stage.

The preprocessing stage can include renormalizing 405, e.g., by CAD program(s) 116 or 3D modeling program(s) 904, the input shape. Note that “renormalizing” a level-set computer-data representation of a 3D shape includes restoring the unit gradient property of a signed distance field without changing the zero contour of the level-set representation, which corresponds to the shape being represented by that level-set representation. In addition to cleaning any imperfections in the signed distance field from previous computations, in implementations that use a narrow band SDF representation (in which the signed distance field is only valid in a narrow band around the zero contour), the renormalizing 405 can also include extending the band width of the SDF representation. In some implementations, the SDF representation is propagated throughout the entire design domain (design space).

In some implementations, the preprocessing stage also includes adding 410 material, e.g., by CAD program(s) 116 or 3D modeling program(s) 904, to the input shape (e.g., the intermediate version of the three-dimensional shape generated in the iterative loop of the optimizer) in accordance with the build angle and the manufacturing direction to increase self-supportability of the input shape. In some implementations, this involves applying a geometry filter to the input shape (e.g., a single pass of a kernel that operates directly on the SDF representation) to introduce some overhang removal on the underside of the input shape. The geometry filter adds material to the input shape to reduce any regions of overhanging geometry in the 3D shape. In some implementations, the geometry filter explicitly generates new geometry for the 3D shape one layer at a time (referred to herein as the layer-based geometry filter) as described in U.S. Patent Publication No. US-2023-0152778-A1, published on May 18, 2023, and entitled, “COMPUTER AIDED DESIGN WITH GEOMETRY FILTERING TO FACILITATE MANUFACTURING”, which is hereby incorporated by reference. In some implementations, new geometry is implicitly generated using a signed distance field update rule in a geometry filter, where the signed distance field is manipulated directly by the geometry filter (as part of the build-angle filter) during shape and/or topology optimization as a shape sculpting process.

This shape sculpting process can seek to create a “nearest equivalent” shape to the one produced by the optimizer while satisfying the requirements of the additive manufacturing process, e.g., minimizing external support material needed for an additive extrusion/deposition manufacturing process, or ensuring mold removability (undercut and void removal, and draft of vertical walls) for a molding manufacturing process. Moreover, regardless of which type of additive manufacturing process is to be used, the build-angle filter can employ the shape sculpting process to inherently accommodate ejection or build directions that are not axis aligned. This is because the geometry filter (using the signed distance field update rule) operates in three dimensions and changes a current value of a discrete element indicating a distance to the implicit surface based on a comparison of the current value with another value and a constant value, where the other value is determined from one or more values found in one or more other discrete elements in the data structure located away from the discrete element along the manufacturing direction, and the constant value is determined for the build angle. A detailed example of this is now provided.

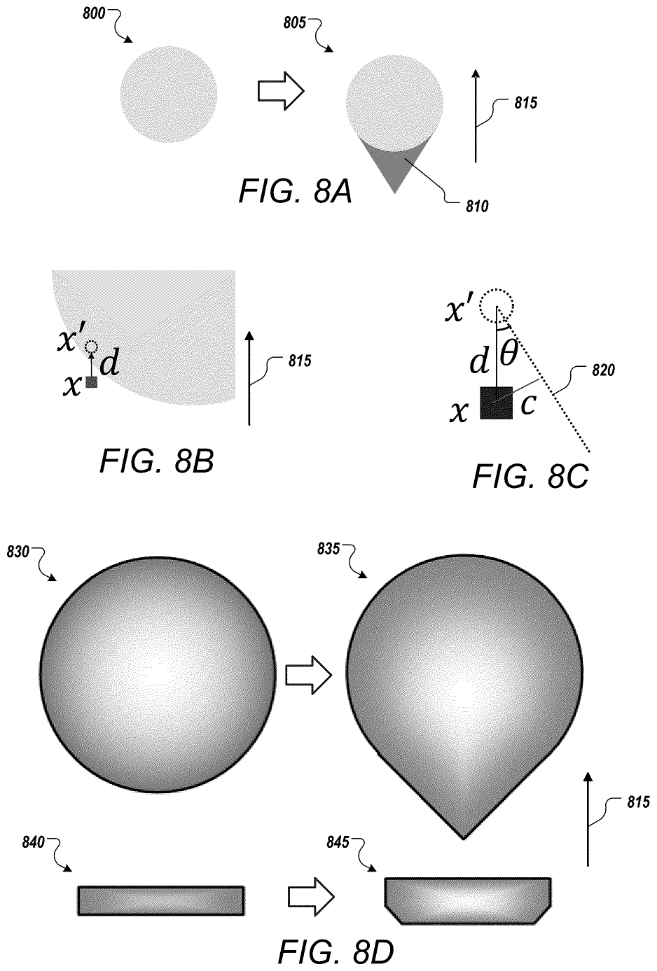

The signed distance field update rule can be applied at each voxel in the signed distance field which represents the shape, as shown schematically in FIGS. 8A-8C. FIG. 8A shows an example of an input shape 800 and its corrected shape 805 after applying a geometry filter employing a signed distance field update rule one or more times to add new material 810 (that is tapered in accordance with the build angle, as shown) that reduces the amount of external support structures that will be needed when manufacturing in the build direction 815.

FIG. 8B shows neighbor sampling for the signed distance field update rule. For each discrete point x (e.g., a voxel in a voxel mesh) an update to the signed distance field at x based on one or more values of the signed distance field in a region “above” the discrete point x (where “above” means that it is further from the build plate along the build direction) can be performed. In some implementations, for each discrete point x in the design domain, the signed distance value is compared to the signed distance value of a “neighbor” point x′ which is located a distance d away along a ray starting at x, parallel to the build direction, as shown in FIG. 8B. Note that when d is one voxel and the build direction is axis-aligned, x′ corresponds to an actual neighboring voxel, but this is not the case in general (the choice of d is an implementation decision, and the build direction need not be axis aligned). In some implementations, d is set at a value of between 1.0 and 1.5 voxel widths (inclusive). Other values of d can be used in various implementations, such as values between 1.5 and 2.0 voxels (inclusive) or 2.0 and 2.5 voxels (inclusive).

FIG. 8C shows a schematic representation for the signed distance field update rule used to implement the shape sculpting geometry filter (also referred to as the 3D geometry filter). Note that an interpolation scheme can be applied to approximate the signed distance field value of x′ in the case that it does not lie exactly on a voxel. Further, having identified the signed distance field value at x (denoted ø (x)) and the (possibly interpolated) signed distance field value at x′ (denoted ø (x′)), the output signed distance field value at x can be set according to the update rule in Equation 1.

$$ϕ ( x ) ← min ( ϕ ( x ) , ϕ ( {x}^{′} ) + c ) \qquad ( 1 )$$

Equation 1 requires that the new signed distance field value be at least as small as the neighbor point's signed distance field value plus a constant offset c. Note that negative signed distance field values are considered interior to the shape being represented in the examples provided, but the opposite approach can also be used in various implementations. Also note that when c=0, overhangs and voids are removed from the design, and increasing the magnitude of c produces the tapered effect shown in FIG. 8A.

Specifically, c can be computed based on the schematic shown in FIG. 8C, in which it is imagined that the neighbor point x′ lies exactly on the zero contour 820. In the case where the signed distance field follows the overhang constraint, the zero contour extends downward from the neighbor point with an angle θ from the build direction (e.g., the critical overhang angle). The signed distance value at x should be c units away from this zero contour, where c is the shortest distance between x and the zero contour. The value of c can computed from this right triangle as,

$$c = d sin ( θ ) . \qquad ( 2 )$$

By applying this rule to each voxel in the domain, the input shape is modified to require less external support structure. Further, as noted above, this geometry filter can be applied in a single pass to achieve the adding 410 (in FIG. 4A) of material, and this geometry filter can subsequently be applied repeatedly, until the shape stops changing, to create a new signed distance field that adds material to the original shape in locations that will reduce the amount of external support structure that will be needed for manufacturing the physical structure being modelled.

In some implementations, the geometry filter is applied iteratively to the voxels in the design domain, beginning with voxels farthest from the build plate along the build direction and proceeding (in order according to the distance from the build plate) to those voxels closest to the build plate. In this way the overhang correction propagates downwards, potentially through multiple voxels, to create the ice cream cone geometry shown in the example of FIG. 8A. Further, in order to keep geometry from seeping through the build plate, which can be selected (without loss of generality) as the bottom plane of the shape along the build direction, a term can be added to Equation 1 to clip the updated signed distance field value at the build plate plane, giving the updated Equation 3 below:

$$ϕ ( x ) ← min ( ϕ ( x ) , max ( ϕ ( {x}^{′} ) + c , {ϕ}_{far} ( x ) ) ) , \qquad ( 3 )$$

where φ_{far} (x) denotes the signed distance field of the half-space defining the build plate (negative above the build plate).

As noted above, this geometry filter can be applied in subsequent operations (described in further detail below) and to support the functionality needed in those subsequent operation, one additional term can be introduced to the signed distance field update rule, which allows a specific region to be excluded from the update, such that the shape does not grow into a certain geometry (a kind of “keep out” or “obstacle” region which applies only to the newly-generated support structures). Given a signed distance field for such an obstacle region do, the following revised update rule can be used:

$$ϕ ( x ) ← min ( ϕ ( x ) , max ( ϕ ( {x}^{′} ) + c , {ϕ}_{far} ( x ) , - {ϕ}_{o} ( x ) ) ) . \qquad ( 4 )$$

In the event that Equation 4 is used when no obstacle region is present, do can be set to a large value everywhere.

Listing 1 below provides an example of pseudocode to implement the geometry filter of Equation 4, according to some implementations.

Listing 1

Given: Build direction bdir, 3D levelset geom, offset distance d, critical

overhang angle theta, obstacle signed distance field obstacle, and
build plate plane bp

Objective: Filter the geometry to remove most overhangs

| | |
|---|---|
| 01 | Let c = d * sin(theta) |
| 02 | For Each voxel from furthest to closest to build plate Do |
| 03 | Let offsetCoord = voxel + d * bdir |
| 04 | If offsetCoord in geom domain Then |
| 05 | Let currentValue = geom.Sample(voxel) |
| 06 | Let offsetValue = geom.Sample(offsetCoord) |
| 07 | Let buildPlateTerm = −bdir.dot(coord − bp.Origin) |
| 08 | Let obstacleTerm = obstacle.Sample(coord) If obstacle Else inf |
| 09 | geom.SetValue(voxel, min(currentValue, max(offsetValue + c, |
| | buildPlateTerm, −obstacleTerm))) |
| 10 | End If |
| 11 | Next voxel |

Further, a second (closely related) form of the geometry filter can be introduced in which the domain is traversed in the opposite direction, has the opposite sense of the offset, and does not include the build plate term. Listing 2 below provides an example of this second form of the geometry filter, which can be understood as a reversed geometry filter.

Listing 2

Given: Build direction bdir, 3D levelset geom, offset distance d, critical

overhang angle theta, obstacle signed distance field obstacle

Objective: Filter the geometry to remove most overhangs

| | |
|---|---|
| 01 | Let c = d * sin(theta) |
| 02 | For Each voxel from closest to furthest to build plate Do // ← note |
| 03 | Let offsetCoord = voxel − d * bdir // ← note |
| 04 | If offsetCoord in geom domain Then |
| 05 | Let currentValue = geom.Sample(voxel) |
| 06 | Let offsetValue = geom.Sample(offsetCoord) |
| 07 | Let obstacleTerm = obstacle.Sample(coord) If obstacle Else inf |
| 08 | geom.SetValue(voxel, min(currentValue, max(offsetValue + c, |
| | −obstacleTerm))) |
| 09 | End If |
| 10 | Next voxel |

As will be appreciated, such variations of the geometry filter can be implemented in a single program procedure or subroutine, by including additional input arguments to determine the execution behavior. The two listings are provided above for clarity in this description, and because separate program procedures or subroutines can also be used in some implementations.

Further, note that the above described signed distance field update rule may not fully synthesize the ice cream cone “cusp” geometry shown in FIG. 8A in one application. This occurs because the level set field on the interior of the structure does not become sufficiently negative since the structure is comparatively thin in the build direction. FIG. 8D shows examples of cusp geometry generation for two different input 3D shapes: a sphere 830, and a beam 840, where level-set SDF values are shown on the interior of the geometry in shades of gray. For the sphere 830, because level-set SDF value becomes sufficiently large on the interior to accurately reflect the distance from the boundary (e.g., the lateral distance from the boundary in the plane perpendicular to the build direction) a single pass of the update rule described in Equations 1, 3 & 4 is sufficient to generate the full cusp geometry in an output shape 835. In contrast, the beam 840 has an aspect ratio that is thinner in the build direction 815 than in another direction. Because of this, when the beam 840 is processed with the SDF update rule, the signed distance field values on the interior of the shape are driven by the distance to the top and bottom faces of the beam 840, and after one application of the SDF update rule, an output shape 845 includes only a partial cusp, which means the required external support structure has not been fully minimized with only one application of the SDF update rule for this input shape.

Nonetheless, the output shape 845 still has better interior level-set geometry than the input beam 840, in that the output shape 845 is less constrained by the bottom face of the shape. Subsequent iterations of the SDF update rule will cause the shape to evolve further downward until the full cusp is generated (at least for overhang angles of 60 degrees or less for additive manufacturing applications). Thus, a single pass the geometry filter (as described above for the adding 410 of material in the preprocessing stage) may not fully generate the cusp bodies, but rather provides a first step in that direction.

In implementations that ensure mold removability (undercut and void removal, and draft of vertical walls satisfy the draft angle) the above described signed distance field update rule is modified to ensure that a point in space is in the interior of the part if its neighbor in the direction away from the parting surface (in the ejection direction) is also in the interior of the part (thus ensuring undercut and void removal) and further requiring that each point be slightly more interior than its away-from-the-parting-surface neighbor (thus ensuring the draft of vertical walls satisfy the draft angle). Thus, the sign of the constant is flipped,

$$c = - d sin ( θ ) ,$$

to create a drafting effect rather than the tapered effect. Further details for implementations that employ the present systems and techniques as a mold removability filter can be found in U.S. Application No. 63/569,672, filed Mar. 25, 2024, and in U.S. Application No. TBD, filed TBD under attorney docket no. 15786-0390001, both entitled, “DRAFT ANGLE SCULPTING OF THREE-DIMENSIONAL MODELS OF PHYSICAL OBJECTS FOR CASTING AND MOLDING MANUFACTURING PROCESSES”, and both of which are hereby incorporated by reference.

Returning to FIG. 4A, in the unsupported region(s) removal stage of the build-angle filter algorithm, supportable material of the input shape that is not currently self-supported is identified 415. Then, this identified material is removed 420 from the input shape, e.g., by Boolean subtraction. The decision to subtract unsupported regions from the current design is a key insight of the present disclosure since the interaction with the optimizer, which continues to evolve the shape based on the one or more design criteria, enables this removal of material that might otherwise create a problem for the modified 3D shape. In particular, the build-angle filter can be designed (as described herein) to limit the amount of material that is removed and the locations of material removal (especially not requiring removal in regions which are unsupportable, i.e., not capable of self-support, which have a correspondingly greater probability of being important to the input shape's integrity) such that the integrity and performance of the input shape are not sacrificed while ensuring self-support in at least one region of the evolving design.

Adding material using an update rule like the geometry filters described above often only minimizes (but does not eliminate) the regions of the design requiring support. In order to further improve the manufacturability of the synthesized shape, material can be removed from the design in regions where that material is not fully self-supported, even though it could plausibly be supported by the current design, thereby providing a better self-supporting design constraint for use during shape and/or topology optimization. The described construction of the build-angle control algorithm enables safe removal of material from the design in the middle of the optimization loop without unduly disrupting the connectivity or performance of the design being optimized. Conventional approaches to geometry filtering in optimization contexts emphasize adding material to the design in order to guarantee that the design does not break or become unduly weakened. In contrast, the present disclosure describes removing material (which would normally be considered too dangerous to do) by crafting the behavior of the filter's effect to restrict the total amount of material removed, limit the regions in which the filter can remove material to avoid unsupportable regions (which have a higher chance of being important to the design's connectivity), and leverage the incremental changes introduced by the optimizer on each iteration (optionally coupled with the velocity filter described below which further reduces the impact of the optimizer's changes on the amount of material the geometry filter removes).

Having the build-angle filter remove material from the design can create a risk that the shape synthesis program will create undesirable disconnections and removal of preserve features. This risk can be addressed in at least two ways, which can be used together or independently. First, a disconnection filter (such as described in U.S. Patent Publication No. US-2024-0126933-A1, published on Apr. 18, 2024, and entitled “COMPUTER AIDED SHAPE SYNTHESIS WITH CONNECTIVITY FILTERING”) can be used to ensure the evolving shape does not break into disconnected pieces. Second, the build-angle filter can be designed to minimize this risk of disconnection by restricting the removal of material to self-supportable region(s), where other parts of the design could provide the self-support for the removed material, and optionally by using a starting shape that is self-supporting in the supportable region(s), e.g., using a convex hull of the input preserve(s), and optionally by using a velocity filter to inform the optimizer of relative impacts of removing region(s) which are supporting other region(s) above them (by propagating design sensitivities along critical faces to avoid unexpected material removal, as described in further detail below).

In any case, after the identified material is removed 420 from the input shape, the region(s) tapering stage adds material 425 in accordance with the build angle and the manufacturing direction to increase self-supportability of the 3D shape (at least outside the 3D region of the design space that has been identified 415 as capable having self-support for any material in that 3D region, i.e., since any un-self-supported material in that identified 3D region should have been fully removed, no material should need be added in that identified 3D region). Adding material 425 can involve applying the geometry filter (described above) repeatedly until the shape stops changing, thereby creating a new signed distance field that adds material to the original shape to substantially minimize the amount of external support structure that will be needed for manufacturing the physical structure being modelled.

In this region(s) tapering stage, any remaining overhanging regions are reduced or eliminated. This stage typically only affects non-self-supporting regions near the bottom of the part design and unsupported regions underneath preserves, but small changes may be present elsewhere as well. In practice, applying the geometry filter (using 3D shape sculpting) once over the domain is not sufficient to fully form cusp regions, thereby reducing any remaining overhanging regions as much as is possible, for reasons described above. Thus, the geometry filter can be applied two or more times, e.g., two, three, four, five or six times, interleaved with level set renormalization.

FIG. 4B shows an example of a 3D model, as that 3D model is modified by the process of FIG. 4A. An input shape 450 consists of two preserve regions 452 and a plate connecting them. During the preprocessing stage, cusp geometry 462 is added to the underside of overhanging features, forming a first modified shape 460. Then, unsupported (but supportable) regions are removed (in the unsupported region(s) removal stage) which creates cutout shapes 472 in the regions near the preserves and also the upward tapering of the hole in the plate, thereby forming a second modified shape 470. Finally, in the region(s) tapering stage, overhanging regions are tapered downwards, thereby created a third modified shape 480 with added material 482. Note that each time the build-angle filter is applied, the shape becomes more self-supporting; in the shape synthesis context, the build-angle filter can be applied after every iteration, so this compounding effect is evident in most real-world applications of the technology. Further, the build-angle filter can be applied repeatedly to an output shape of a shape synthesis process to ensure the final shape is as self-supporting as possible.

Various approaches can be taken for identifying the 3D region of the design space that is capable having self-support for any material in that 3D region (i.e., identification of the supportable region in the design). In some implementations, the geometry filter is used to create a void region that should not be occupied by material in the design. Further, in some implementations, this void region is adjusted to avoid numerical errors (see the description of shrinking non-overhanging portions of the void region below). In either case, the void region is subtracted from the current design to eliminate unsupported region(s) of the current design, thus effecting the identifying 415 and the removing 420.

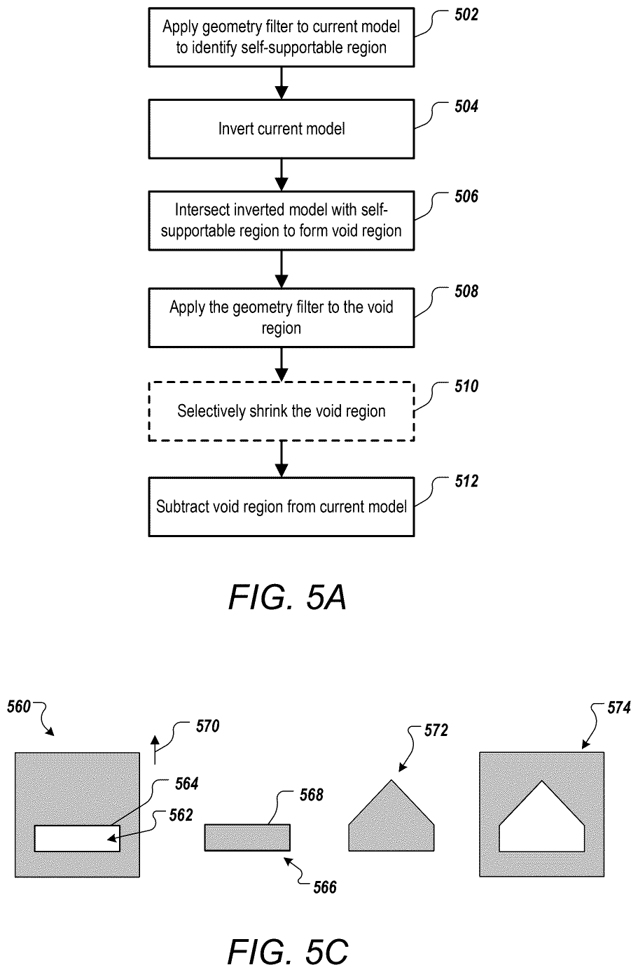

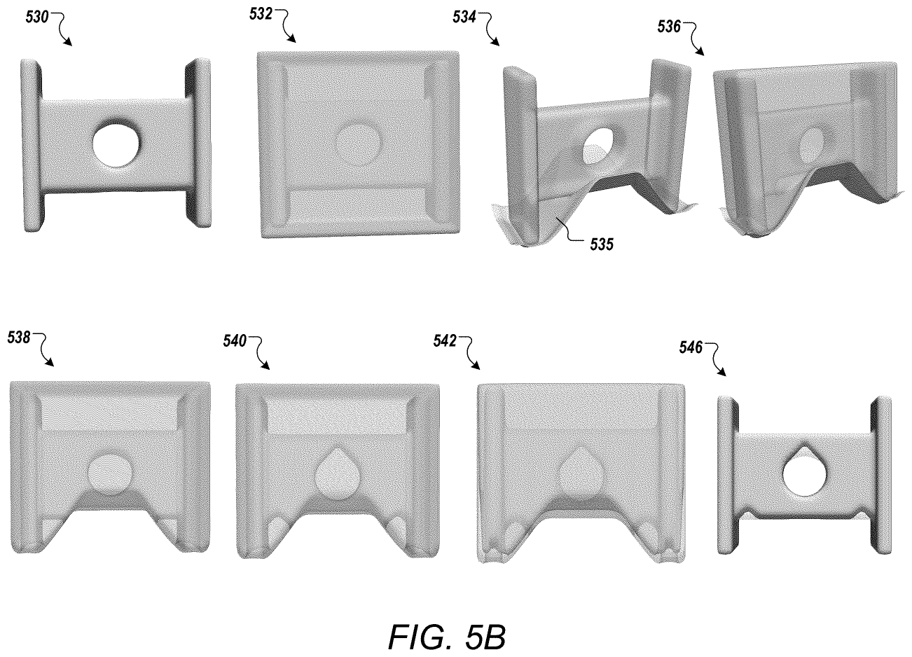

FIG. 5A shows an example of a process for identifying and then removing portion(s) of an input shape that are not self-supported even though full-self support is possible in that region of the design space for the input shape. In the detailed example provided in connection with FIG. 5A, a “void” region signed distance field is produced, where this void region is initialized as the compliment to the signed distance field of the current design (i.e., φᵥ(x)=−φ(x)∀x; the interior of the void signed distance field is the exterior of the current design signed distance field). A geometry filter (as described herein) is applied 502, e.g., by CAD program(s) 116 or 3D modeling program(s) 904, to the current model (the 3D shape input to the build-angle filter) to identify the self-supportable region. For example, the geometry filter can be applied to a level-set computer-data representation of the intermediate version of the 3D shape in the manufacturing direction (e.g., the reversed geometry filter is used with the negative build angle θ) to identify the 3D region of the design space that is capable of being self-supported by the intermediate version of the three-dimensional shape, as now described in detail.

As discussed above, this identification of the self-supportable region enables restriction of the region in which a self-supporting design is required to only those regions that might reasonably be self-supporting. Thus, as in the example of FIG. 1 where the second region 134B has existing design geometry (found in the current 3D model 132, in the preserve bodies 133A, or both) that can be used to provide self-support for the physical structure (during manufacturing), the region(s) of the design that are plausibly supportable by another region of the design (including taking any preserves into consideration) can be identified in order to determine the dividing line between a first region of the design space where self-support is encouraged (but not required since requiring some external support structures in this region will likely be preferable to over-constraining the design freedom of the optimizer in the iterative loop) and a second region of the design space where self-support is required.

In some implementations, before the application 502 of the geometry filter, a copy of the current model is made for this application 502, and that copy of the model is renormalized to a wide bandwidth. In some cases, the signed distance field is extended all the way to the edge of the design domain in order to simplify renormalization process. In any case, the application 502 of the geometry filter causes the 3D shape to be drafted outwards as the geometry filter moves upwards (in the manufacturing direction in this example) from the build plate. For example, a resulting 3D model 534 in FIG. 5B shows a surface 535 of the processed 3D shape resulting from the drafting outwards process, after application of the reversed geometry filter to an input 3D model 530, which corresponds to the input shape 450 when the two preserve regions 452 are considered part of the model along with the plate connecting those preserves, as is common during shape modification in an iterative shape and/or topology optimization loop.

In the resulting 3D model 534 in FIG. 5B, the exterior of the signed distance field surface is down (from the surface 535) towards the build plate, and the interior is upwards (from the surface 535). This interior portion of the signed distance field (after the application 502 of the geometry filter) represents the region of the current model where self-support is clearly possible and so will be required (also referred to as the “supportable signed distance field”). In some implementations, this supportable signed distance field will be Boolean intersected with a void region signed distance field such that the void region considered in subsequent operations is only that portion of the design space that lies above the supportable surface, as described below. In general, this void region (or “void body”) can be formed by applying the geometry filter to a level-set computer-data representation of all portions of the design space that are both exterior to the intermediate version of the three-dimensional shape (the initial void region) and are within the three-dimensional region of the design space identified as capable of being self-supported by the intermediate version of the three-dimensional shape.

Thus, in this implementation example, the current model (the 3D shape input to the build-angle filter) is inverted 504, e.g., by CAD program(s) 116 or 3D modeling program(s) 904. For example, an inverted 3D model 532 (the initial void region) is shown in FIG. 5B, which is the result of inverting the input 3D model 530. Note that the order of the inverting 504 of the current model and the application 502 of the geometry filter to the current model does not matter, and in some implementations these operations are performed in parallel. In any case, the inverted model is Boolean intersected 506, e.g., by CAD program(s) 116 or 3D modeling program(s) 904, with the self-supportable region to form the void region (also referred to as void body or void shape). In other words, the void region (or void body) is initialized to be the compliment of the current shape and then is intersected with the supportable region to form the void region(s) that will be removed from the input design because those portion(s) of the input design are not self-supported but could be self-supported. For example, a 3D model 536 in FIG. 5B shows the result of intersecting the inverted 3D model 532 with the resulting model 534, thus representing the inversion of the current design with all portions in the region where self-support will not be required having been removed.

Note that, if the current shape contains no unsupported regions, the corresponding void shape should have no top faces that overhang in the opposite direction of the actual build. FIG. 5C shows an example of void shape generation and subtraction from a current shape 560. The current shape 560 includes a rectangular hole 562 in the middle (note that this example presumes that the bottom of the current shape 560 is touching the build plate or is not self-supportable, and so is not subject to the modifications discussed here). The rectangular hole 562 has a top face 564 that is overhanging with respect to a build direction 570. Rather than merely adding geometry (i.e., additional material) to the current shape 560 to create self-support for the top face 564, the present systems and techniques can remove geometry (i.e., remove material) from the current shape 560 to make it self-supporting. To do this, a void body 566 can be created from the current shape 560 (note that only a portion of the true void body, corresponding to the rectangular hole 562, is shown to facilitate clarity in the visualization).

The void body 566 is the complement of the current shape 560 and so has a top face 568 that is overhanging with respect to a vector that is opposite to the build direction 570. Thus, the geometry filter can be applied to the void body 566 to correct the overhang by projecting the void geometry upwards to form a kind of reverse cusp, creating a modified void body 572, which satisfies the build angle (with reference to the vector that is opposite to the build direction 570). And when the modified void body 572 is subtracted from the current shape 560, a modified shape 574 is produced that satisfies the build angle with reference to the build direction 570.

Thus, as shown in FIG. 5A, the geometry filter can be applied 508, e.g., by CAD program(s) 116 or 3D modeling program(s) 904, to the void region to extend it in a manner that satisfies the build angle from the opposite direction. For example, the geometry filter can be applied to a level-set computer-data representation of the void region (also referred to as a void body or void shape) in the manufacturing direction (e.g., the reversed geometry filter is used) to produce a modified version of the void region. Thus, applying the reversed geometry filter to the void body creates cusps on the top of overhanging voids with respect to a backwards build direction. Note that the reversed geometry filter of Listing 2 expects the normal build direction as an input, and performs the flipping internally. In addition, any preserves can be provided as an obstacle body, thereby ensuring that material from the preserve bodies is not removed and ensuring that void cusps are not allowed to penetrate through preserve bodies and appear on the other side. Moreover, in some implementations, two or more (e.g., six) applications of the geometry filter are used on the void body (e.g., interleaved with level-set renormalizations, which can be partial or full renormalizations, for a level-set implementation) to ensure that the cusps are sufficiently steep to fully meet the critical overhang angle.

In any case, the modified version of the void region is subtracted 512, e.g., by CAD program(s) 116 or 3D modeling program(s) 904, from the current model (e.g., from the intermediate version of the three-dimensional shape) to remove the portion of the current model (e.g., a portion of the level-set computer-data representation of the intermediate version of the three-dimensional shape) that is not self-supporting even though it is in a region of the design space where full self-support is possible in view of that current model (including any preserves). This subtraction of the void body from the current shape removes any regions of the current model that are not self-supporting even though they could be. Further, in some implementations, a Boolean union is performed between any preserves and the shape after the subtraction 512 to ensure that no preserve regions were incorrectly removed, although in practice, this should be prevented by including the preserves as obstacles in the application of the reversed geometry filter described above.

In some implementations, the void region is selectively shrunk 510, e.g., by CAD program(s) 116 or 3D modeling program(s) 904, before the void region is subtracted 512 from the current model. For example, in a level-set implementation using renormalization of the signed distance field, each renormalization perturbs the zero contour slightly due to roundoff error. As a result of this, directly subtracting the void region from the current model can cause noisy artifacts to appear in regions far from any overhangs. To eliminate this generation of undesirable artifacts in the current model, a selective shrinking of regions in the void body that are not overhanging can be performed, effectively keeping those regions from participating in the Boolean subtraction.

To do this, the process can iterate through the voxels in the void body from the build plate upwards along the build direction (similar to the reversed geometry filter), and an offset level-set value can be computed a distance d along the backwards build direction. The difference between the signed distance field value at the current voxel and that sampled at the offset coordinate can be computed and then divided by the overhang threshold c, and be clamped to 0-1. This “overhang safety” value will be zero in regions that are nearly overhanging (with respect to the reversed build direction) and one in regions that are not overhanging. A correction value can be computed from the overhang safety value by multiplying by a shrinking amount, e.g., 0.2 voxel widths, and the correction value can be added to the current void voxel's signed distance field value. Listing 3 shows an example of an algorithm in pseudocode to perform this shrinking of non-overhanging regions in the void body.

Listing 3

Given: Build direction bdir, 3D void levelset geom, offset distance d,

critical overhang angle theta, shrinkage amount s, and overhang
margin m

Objective: Filter the geometry to slightly shrink non-overhanging void
regions while leaving overhanging regions untouched

| | |
|---|---|
| 01 | Let c = d * sin(theta + m) |
| 02 | For Each voxel from closest to furthest to build plate Do |
| 03 | Let offsetCoord = voxel − d * bdir |
| 04 | If offsetCoord in geom domain Then |
| 05 | Let currentValue = geom.Sample(voxel) |
| 06 | Let offsetValue = geom.Sample(offsetCoord) |
| 07 | Let overhangSafety = clamp((offsetValue − currentValue) / |
| | c, 0, 1) |
| 08 | Let correction = overhangSafety * s |
| 09 | geom.SetValue(voxel, currentValue + correction) |
| 10 | End If |
| 11 | Next voxel |

In the above, the function clamp (x, a, b) returns x if a<x<b, a if x<a and b if x>b. Note that, because the input shape is a void shape, “shrinking” implies an outward motion of the boundary, so this can also be understood as inflating non-overhanging regions. Further, a margin value greater than (e.g., m=12 degrees) zero can be used in some implementations to minimize shrinking in overhanging regions even if they aren't quite at the critical threshold (e.g., a few degrees of margin above the overhang angle) so the filter remains maximally effective, thereby improving the results.

In FIG. 5B, the 3D model 536 (which is shown in a perspective view) is also shown in a straight-on side view as 3D model 538. The 3D void model 538 represents the inverted model 532 with the region that will not have full self-support required removed, i.e., the void region discussed above in connection with FIG. 5A. A 3D void model 540 represents the 3D void model 538 after it has been extended in a manner that satisfies the build angle from the opposite direction, i.e., enlarged in regions where the original geometry has overhanging surfaces that can be supported, thus creating the shape that will be used to remove material from the input shape to create the output shape. A 3D void model 542 represents the 3D void model 540 after selective shrinking of the void region to avoid changing non-overhanging regions of the current model (note that the shrinking has been exaggerated for the 3D void model 542 to make the shrinking more visible in FIG. 5B). And 3D model 546 represents the result of subtracting the 3D void model 542 from the input 3D model 530, where the 3D model 546 is now fully self-supporting in the region of the design domain where full self-support is possible.

In some implementations, the signed distance field of a level-set computer-data representation of the current shape is processed in a manner that accelerates operation of the build-angle filter. Various techniques are known for generating a signed distance field that is accurate far from the zero contour, i.e., not just in a narrow-band around the zero contour (e.g., between two and four voxels, or between two and ten voxels, on either side of the zero contour). In shape and topology optimization algorithms, only a narrow-band (around the zero contour) signed distance field is typically needed, which allows such algorithms to run faster. But the build-angle filter described in this document can require a signed distance field that is accurate far from the zero contour, i.e., in a relatively wide band (e.g., extending by a number of voxels on either side of the zero counter that go between half way and all the way to the edge of the design domain. To efficiently (in terms of processing resources) compute a desired accuracy in the signed distance field, an adaptation of the techniques described in Zhao, A FAST SWEEPING METHOD FOR EIKONAL EQUATIONS, Mathematics of computation, Vol. 74, No. 250, pp. 603-627 (2005), can be used. Essentially, an ordered voxel traversal of the signed distance field in different directions can be performed in a manner that significantly improves speed of propagating the signed distance field away from the zero contour.

The technique(s) from Zhao can be used to expand the narrow band level set to cover the entire domain using an ordered traversal of the voxels. For example, six orderings of the voxels interior to the domain (i.e., not those on the outer surface of the voxel grid) can be computed, corresponding to both positive and negative traversals along each of the coordinate axes (i.e., +X, −X, +Y, −Y, +Z, −Z, where X, Y, and Z are the local coordinate system in which the voxel grid is contained). A kernel which updates a voxel by solving the Eikonal equation using a first-order upwind finite difference scheme is constructed, which adjusts the value of an input voxel based on the values of its neighbors to make the upwind gradient magnitude approximately 1.0. The kernel is applied at each interior voxel in each of the orderings successively, allowing the underlying signed distance field to be updated in-place. In some implementations, an outer loop performs the updates along each of the orderings more than once (i.e., each interior voxel in the domain can be updated once by each of the orderings in a series such as +X, −X, +Y, −Y, +Z, −Z, +X, −X, +Y, −Y, +Z, −Z, etc. for a pre-defined number of outer loop executions).

Finally, border voxels on the edge of the domain can have their values updated using neighboring interior voxels. An upwind finite difference scheme can be employed, but in some cases it is sufficient to set each border voxel equal to its nearest interior neighbor's value. Further, the algorithm that implements the Eikonal equation solution needed by the kernel, as described in Zhao, can be used in some implementations.

The number of times the signed distance field update rule needs be applied to all voxels in the design domain before the shape stops changing depends on the distance over which information must travel for the build angle constraint to be satisfied. For example, a tall part (along the build direction) might require many more iterations than a shallow part before convergence is reached. The speed of the geometry filter can be improved by reordering the voxels based on their distance along the build direction such that every time a neighbor point is sampled, it only leverages voxels which have already been updated. By ordering this way, the number of passes over the design domain can be reduced, potentially to a single pass.

Further, as noted above, the renormalizing 405 (to restore the unit gradient property of a signed distance field without changing the zero level set, which corresponds to the shape being represented by it) can include extending the band width of the signed distance field representation. In some implementations, the signed distance field band width is extended outward to a distance of hₘₐₓ sin (0)+b, where hₘₐₓ is the maximum distance from the build plate (or parting surface in the case of casting, forging or molding implementations) along the build direction (or ejection direction) of any domain element, and b specifies a buffer (e.g., 2-3 voxel widths) to ensure one stays significantly away from zero values at the build plate (or parting surface), or where hₘₐₓ is the maximum distance from the build plate (or parting surface in the case of casting, forging or molding implementations) to a farthest corner of a bounding box for the current model.

In some implementations, the signed distance field band width is extended outward all the way, i.e., the signed distance field representation is propagated throughout the entire design domain (design space). In some implementations, renormalizing the signed distance field is handled differently in different portions of the algorithm. For example, first signed distance field renormalization code that operates in the narrow band around the zero contour can be used in a traditional manner in the shape and/or topology optimization loop, and the renormalizing 405 can use the first signed distance field renormalization code in the narrow band, but use second signed distance field renormalization code (as described above) away from the narrow band, thus avoiding changing the shape being represented in the shape and/or topology optimization loop.

In some implementations, any input preserves are preprocessed to reduce the amount of processing resources used in the region(s) tapering stage. Generating cusps underneath thin preserve geometries can require many more applications of the geometry filter in the region(s) tapering stage described above than other areas of the design. To address this issue, the tapered (cusp) geometries for the preserves can be pre-computed at the beginning of the optimization run. Referring to FIG. 3A, any input preserves can be preprocessed 312, e.g., by CAD program(s) 116 or 3D modeling program(s) 904, to enlarge them, e.g., by applying the geometry filter up to thirty times, with interleaved renormalization of the signed distance field representation of the preserve(s). These tapered (i.e., enlarged) preserves can then be used in place of the original preserves as input to the shape synthesis process, including during application of the build-angle filter. Using these enlarged preserves in the Boolean union with the output shape (e.g., the shape after the subtraction 512) ensures the preserves are fully present in the design.

In practice, this produces good output geometry from the build-angle filter, but the bubble insertion algorithm (which creates new voids inside the material domain of the current design to allow the level set to evolve more freely) tends to add bubbles inside the cusp geometry below the preserves when this portion of the geometry does not appear important to the optimization objective. To address this issue, bubble insertion can be prevented 317, e.g., by CAD program(s) 116 or 3D modeling program(s) 904, inside the enlarged version of the one or more preserve bodies during the shape and/or topology optimization loop. In other words, the full tapered preserves are excluded from bubble generation.

Extensive details are provided above for the geometry filter being implemented using the signed distance field update rule, which operates in three dimensions (referred to herein as the 3D geometry filter). However, as noted above, the geometry filter can be implemented to generate new geometry for the 3D shape (e.g., in adding 410 and adding 425) one layer at a time, as described in U.S. Patent Publication No. US-2023-0152778-A1, published on May 18, 2023, and entitled, “COMPUTER AIDED DESIGN WITH GEOMETRY FILTERING TO FACILITATE MANUFACTURING” (referred to herein as the layer-based geometry filter). This layer-based geometry filter extracts a two dimensional profile from a first discrete layer of an input three-dimensional shape, offsets the two-dimensional profile in accordance with the build angle to form an offset two-dimensional profile, and changes a second discrete layer of the input three-dimensional shape using offset two-dimensional profile.

Using slices of the shape parallel to the build plate (or parting surface) and performing computations on two-dimensional level sets in each of the slices substantially reduces the amount of processing resources needed to run the build-angle filter. Note that creating the reversed and inverted-reversed versions of the layer-based geometry filter (and using stacks of slices of the domain to represent and create the input shape, void shape, supportable region, and final shape) will be readily apparent in view of the description above. For further algorithmic details, see US-2023-0152778-A1 at paragraphs 83-90, which correspond to FIG. 2A and FIG. 3, along with paragraphs 138-147, which are hereby incorporated by reference. These algorithmic details are similar to the layer-based geometry filter of the present application since they take a build direction, an input 3D level set, and a critical overhang angle as input. For the 2D, layer-based geometry filtering approach, the algorithm already implicitly sets the layer spacing (which corresponds to d in the level set update rule) to 1 voxel, and implicitly selects the build plate using the extents of the input object in the build direction.

To adapt this algorithm for the present application, the build plate plane can be parameterized instead of computing it automatically (this requires a small tweak in paragraph 145 to use the provided build plate plane instead of computing it). Further, an obstacle should be incorporated into the algorithm in Table 1 of US-2023-0152778-A1. To do this, a matching set of layers of the obstacle body can be created [line 01b: obstacleSlices=Slice VolumeTopToBottom (obstacle, bdir)], then the obstacle slice is Boolean subtracted from the layer after line 6: [line 06b: layerPlusSupport=BooleanDifference (layerPlusSupport, obstacleSlices [layer.id]]. These changes cause the algorithm in Table 1 of US-2023-0152778-A1 to functionally match the layer-based geometry filter of the present application.

Further, for the reversed layer-based geometry filter, the for loop in Table 1 of US-2023-0152778-A1 can be allowed to run backwards (i.e., line 4 becomes for each layer in layersIn.reversed ( )), and the build plate term can be removed entirely from Table 2 of US-2023-0152778-A1 (line 09 becomes geom [voxelId]=min (layerOut [pixel], geom [voxelId])), as it is not used in the reversed layer-based geometry filter. In some implementations, the supportable region identification filter can also be implemented using a layer-based filter, which is functionally similar to the reversed layer-based geometry filter but has a negative overhang angle. Adaptation of the layer-based geometry filter to the inverted-reversed geometry filter and masked inverted-reversed geometry filter will be straightforward to implement.

However, while this layer-based approach operates significantly faster than the 3D algorithm described above, it can produce generally lower quality output geometry because the 2D level sets introduce errors when projected back into three dimensions. This can be addressed (at least in part) by adjusting the level set renormalization used on line 5 of Table 1 in US-2023-0152778-A1. Further, in some implementations, the behavior of Table 2 in US-2023-0152778-A1 can be enhanced such that the level set produced is more signed distance field-like by taking into account the proximity to out-of-plane geometry when placing the 2D signed distance field values back into the 3D scene, thus causing the resulting level set to maintain the unit gradient property. For example, this can be done by decomposing orthogonal components of a signed distance field through a transformation, which enables combining the 2D level set with some information from previous layers to produce a more correct signed distance field.

Finally, note that there may be no need to project back into the 3D shape until the process is done; it is possible to chain multiple layer-wise operations in series, i.e., utilizing only Table 1 in US-2023-0152778-A1, and retain the shape as a series of 2D level set slices in between operations instead of projecting back to 3D using Table 2 in US-2023-0152778-A1. This will improve the speed and reduce roundoff errors introduced by the projection operation and may reduce the need for extensive renormalization of the 2D level set fields when multiple kernels are performed successively. For example, all of the operations in FIG. 5B can (in some cases) be performed using 2D level set-based geometry filtering operations, and executed sequentially on the layer-wise representation of the geometry with a single projection back to 3D space at the end of the procedure (i.e., to create 546 in FIG. 5B).

In any case, in view of the fact that the layer-based approach will operate significantly faster (but with lower quality output geometry) than the 3D algorithm, in some implementations, a dynamic determination is made, e.g., by CAD program(s) 116 or 3D modeling program(s) 904, as to whether to use the 3D geometry filter or the layer-based geometry filter in view of current runtime processing demands. In some implementations, the layer-based geometry filter is used during a first set of iterations of the shape and/or topology optimization loop, and the 3D geometry filter is used during a second, subsequent set of iterations of the shape and/or topology optimization loop, as the synthesized design approaches the final design output.

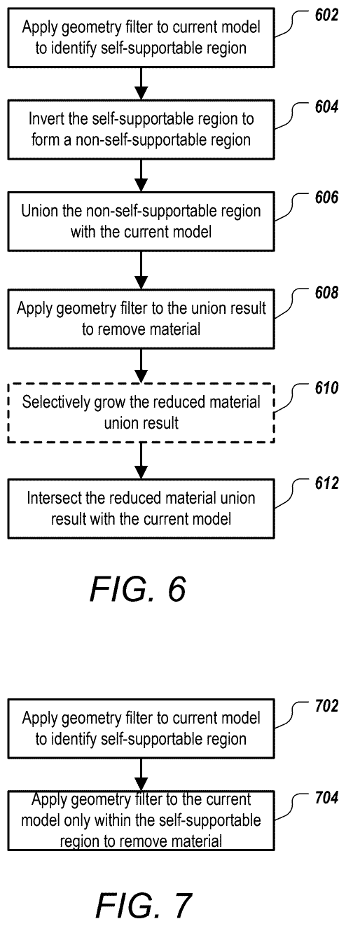

In addition, some implementations remove portion(s) of an input shape that are not self-supported without inverting the current model and/or using a void region, as described above. FIG. 6 shows another example of a process for identifying and then removing portion(s) of an input shape that are not self-supported even though full-self support is possible in that region of the design space for the input shape. In this example, a void region is not created, and the process operates on the input shape (or a copy thereof) directly.

A geometry filter (as described herein) is applied 602, e.g., by CAD program(s) 116 or 3D modeling program(s) 904, to the current model (the 3D shape input to the build-angle filter, e.g., the level-set computer-data representation of the intermediate version of the three-dimensional shape) to identify the self-supportable region. For example, the geometry filter can be applied to a level-set computer-data representation of the intermediate version of the 3D shape in the manufacturing direction (e.g., the reversed geometry filter is used with the negative build angle θ) to identify the 3D region of the design space that is capable of being self-supported by the intermediate version of the three-dimensional shape.

As discussed above, this identification of the self-supportable region enables restriction of the region in which a self-supporting design is required to only those regions that might reasonably be self-supporting, e.g., the second region 134B in the example of FIG. 1 can be identified. For example, the application 602 of the geometry filter can produce a model representing the region of the design domain (for the current model) where self-support is clearly possible and so will be required. Also, in some implementations, before the application 602 of the geometry filter, a copy of the current model is made, and that copy of the model is renormalized to a wide bandwidth, as described above.

In any case, the self-supportable region is then inverted 604, e.g., by CAD program(s) 116 or 3D modeling program(s) 904, to form a non-self-supportable region of the design space. Then a Boolean union of the non-self-supportable region of the design space with the current model is formed 606, e.g., by CAD program(s) 116 or 3D modeling program(s) 904. For example, a union level-set computer-data representation of the non-self-supportable region combined with a level-set computer-data representation of the intermediate version of the three-dimensional shape can be formed.

A geometry filter is applied 608, e.g., by CAD program(s) 116 or 3D modeling program(s) 904, to the union result to remove material from it. For example, a second geometry filter can be applied 608 to the union level-set computer-data representation to form a reduced material level-set computer-data representation. Note that the geometry filter applied at 602 and the geometry filter applied at 608 can be considered to be first and second geometry filters, due to their different operations, even if implemented using a single program procedure or subroutine, as noted above in connection with Listings 1 & 2. In any case, the second geometry filter can be referred to as an inverted-reversed geometry filter, where the “inverted” portion does not reference operation on a void object but rather indicates that the effect of the filter is the inverse of the normal geometry filter, namely, unsupported regions are eroded and removed instead of extended and tapered.

In other words, the inverted-reversed geometry filter applied at 608 causes tapers to be cut upwards into overhanging regions, removing material from the input shape. However, this removal will be effective only in geometry which is not too close to the supportable surface boundary between the self-supportable region and the non-self-supportable region. Thus, in the case of additive extrusion or deposition manufacturing, any portion of the current model that is in contact with the build plate will not be modified since it is at the supportable surface boundary, but any overhanging region of the current model that is not on next to the supportable surface boundary will be tapered upwards (removing material from the input shape) such that no overhangs (violating the critical overhang angle) remain. In the example of FIG. 5C, the current shape 560 is directly processed to form the modified shape 574, without use of the void body 566.

In addition to not including the build plate in the formulation of the inversed-reversed geometry filter (as with the reversed geometry filter, since the filter traverses upwards away from the build plate), some additional changes to the filter algorithm are needed to turn the obstacle term into a preserve term. Listing 4 below provides an example of the inversed-reversed geometry filter.

Listing 4

Given: Build direction bdir, 3D levelset geom, offset distance d, critical

overhang angle theta, and preserve signed distance field preserve

Objective: Filter the geometry to remove overhangs by cutting away

| | |
|---|---|
| | overhanging regions |
| 01 | Let c = d * sin(theta) |
| 02 | For Each voxel from closest to furthest to build plate Do |
| 03 | Let offsetCoord = voxel − d * bdir |
| 04 | If offsetCoord in geom domain Then |
| 05 | Let currentValue = geom.Sample(voxel) |
| 06 | Let offsetValue = geom.Sample(offsetCoord) |
| 07 | Let preserveValue = preserve.Sample(coord) If preserve Else |
| | inf |
| 08 | geom.SetValue(voxel, max(currentValue, min(offsetValue − c, |
| | preserveValue))) |
| 09 | End If |
| 10 | Next voxel |

Several differences can be seen between Listing 4 (inverted-reversed geometry filter) and Listing 2 (reversed geometry filter). Obstacles (which previously prevented the creation of geometry where it shouldn't be) have been replaced by preserves (which prevents removal of geometry where it shouldn't be removed). Line 08 of Listing 4 contains a min ( ) function instead of a max ( ) function to support this, and the preserve value is not negated, as is done for the obstacle value in line 09 of Listing 2; this can be thought of as a switch from a Boolean subtract to a Boolean union. Further, the effect of the filter is to remove geometry instead of add it. In Line 08 of Listing 4, the current value is combined with the correction terms using max ( ) function instead of min ( ) function (compare with line 08 of Listing 2) which effectively switches from a Boolean Union to a Boolean Intersection.

As with the example described in connection with FIG. 5A, in some implementations, two or more (e.g., six) applications of the geometry filter are used (e.g., interleaved with level-set renormalizations, which can be partial or full renormalizations, for a level-set implementation) to ensure that the cusps are sufficiently steep to fully meet the critical overhang angle. Further, because the renormalizations may introduce surface noise, in some implementations, the reduced material union result (provided as output from the application 608 of the geometry filter) can be selectively grown 610, e.g., by CAD program(s) 116 or 3D modeling program(s) 904, before intersection 612 with the current model, in order to ensure that undesirable noisy artifacts are not created in regions far from any overhangs. For example, in a level-set implementation using renormalization of the signed distance field, a filter akin to the shrinking of non-overhanging regions can be applied, but in this case the sign of the behavior is inverted to cause non-overhanging regions to grow outwards slightly. For example, in Listing 3, line 03, the offset direction is inverted since the process is now concerned with overhangs in a non-void region, and the sign of s is changed to negative (shrinkage is changed to growth) so that the shape grows outwards in non-overhanging regions.

Then, the reduced material union result (provided as output from the application 608 of the geometry filter or the output from the selective growth 610) is Boolean intersected 612, e.g., by CAD program(s) 116 or 3D modeling program(s) 904, with the current model to remove the portion of the current model (e.g., a portion of the level-set computer-data representation of the intermediate version of the three-dimensional shape) that is not self-supporting even though it is in a region of the design space where full self-support is possible in view of that current model (including any preserves). Since both the portion of the non-self-supportable region that is outside of the model (as created from the Boolean union 606) and (optionally) the slightly-too-thick non-overhanging regions of the design (added during the selective growth 610) are not present in the current model, both of these portions are removed by the Boolean intersection 612, such that the impact of the Boolean intersection 612 is to remove the regions of the current model that were removed by the inverted-reversed geometry filter at application 608.

FIG. 7 shows yet another example of a process for identifying and then removing portion(s) of an input shape that are not self-supported even though full-self support is possible in that region of the design space for the input shape. A geometry filter (as described herein) is applied 702, e.g., by CAD program(s) 116 or 3D modeling program(s) 904, to the current model (the 3D shape input to the build-angle filter) to identify the self-supportable region. For example, the geometry filter can be applied to a level-set computer-data representation of the intermediate version of the 3D shape in the manufacturing direction (e.g., the reversed geometry filter is used with the negative build angle θ) to identify the 3D region of the design space that is capable of being self-supported by the intermediate version of the three-dimensional shape.

As discussed above, this identification of the self-supportable region enables restriction of the region in which a self-supporting design is required to only those regions that might reasonably be self-supporting, e.g., the second region 134B in the example of FIG. 1 can be identified. For example, the application 702 of the geometry filter can produce a model representing the region of the design domain (for the current model) where self-support is clearly possible and so will be required. Also, in some implementations, before the application 702 of the geometry filter, a copy of the current model is made, and that copy of the model is renormalized to a wide bandwidth, as described above.

Then, a geometry filter is applied 704, e.g., by CAD program(s) 116 or 3D modeling program(s) 904, to the current model (the 3D shape input to the build-angle filter) only within the self-supportable region. For example, a second geometry filter can be applied 704 to the level-set computer-data representation of the intermediate version of the three-dimensional shape within the identified self-supportable region. Note that the geometry filter applied at 702 and the geometry filter applied at 704 can be considered to be first and second geometry filters, due to their different operations, even if implemented using a single program procedure or subroutine, as noted above in connection with Listings 1 & 2. In any case, the second geometry filter can operate using the self-supportable region as a mask for operations of the geometry filter, thus no Boolean operations need be used in such implementations, and this can be referred to as a masked inverted-reversed geometry filter. Listing 5 below provides an example of the masked inversed-reversed geometry filter.

Listing 5

Given: Build direction bdir, 3D levelset geom, offset distance d, critical

overhang angle theta, signed distance field mask, and preserve signed
distance field preserve

Objective: Filter the geometry to remove overhangs by cutting away

| | |
|---|---|
| | overhanging regions |
| 01 | Let c = d * sin(theta) |
| 02 | For Each voxel from closest to furthest to build plate Do |
| 03 | Let offsetCoord = voxel − d * bdir |
| 04 | Let offsetFurther = voxel − 2 * d * bdir |
| 05 | If offsetCoord in geom domain Then |
| 06 | Let currentValue = geom.Sample(voxel) |
| 07 | Let offsetValue = geom.Sample(offsetCoord) |
| 08 | Let preserveValue = preserve.Sample(coord) If preserve Else |
| | inf |
| 09 | Let maskValue = mask.Sample(offsetFurther) |
| 10 | Let t = clamp(maskValue / voxelSize, 0, 1) |
| 11 | Let correction = c * (1 − t) + d * t |
| 12 | geom.SetValue(voxel, max(currentValue, min(offsetValue − |
| | correction, preserveValue))) |
| 13 | End If |
| 14 | Next voxel |

Thus, the identified self-supportable region can be used in the masked inversed-reversed geometry filter in the form of a mask, which restricts the region of the design domain in which the geometry filter is applied. This mask can be offset-sampled in a way similar to the offset value of the geometry (see line 09 of Listing 5). Another approach for this is to shift the whole mask signed distance field by 2d voxels (e.g., upwards by 2d voxels away from the build plate) to ensure that surface which is touching the supportable surface becomes fully interior before the filter is activated (unmasked).

In the case of offset-sampling, the mask signed distance field value can be manipulated to produce an interpolant t that varies from 0 to 1 as the mask signed distance field leaves the mask surface and moves outwards by one voxel (i.e., t=0 corresponds to the sampled point in the mask being interior or on the mask surface, and t=1 occurs when the sampled point is at least one voxel away from the boundary on the exterior). The correction term c is then adjusted using the interpolant t such that correction has the value of c when t is zero (i.e., when the filter is operating on the interior of the mask region) and takes the value d when t is one, with intermediate values of t resulting in a smooth interpolation between the two extreme values. This correction of the c term causes the filter to be ineffective when the current point is sufficiently far away from the mask volume because when correction=d, the offsetValue−correction term in Line 14 becomes smaller than the smallest reasonable value for currentValue. The reason for this is that, in a signed distance field, the maximum change in the field over a distance d can be at most d units. So offsetValue−correction=offsetValue−d≤currentValue by construction because offsetValue is sampled d units away from currentValue. In this case, the max operator always chooses currentValue and the operation has no effect.

In some implementations, a velocity filter is used, in addition to the various build-angle filter implementations described in this document. Thus, referring again to FIG. 3A, before the 3D shape of the modeled object is updated 330, the numerical assessment produced by the numerical simulation 320 can be modified 325, e.g., by CAD program(s) 116 or 3D modeling program(s) 904, by changing values of the numerical assessment in a first region based on values of the numerical assessment in a second region that is supported by the first region in accordance with the build angle, thereby forming a modified numerical assessment for the updating 330. The motivation for using such a velocity filter comes from the removal of unsupported but supportable regions of the current design by the build-angle filter. When the optimizer elects to remove a piece of geometry which is critical to the support of regions above it, the overhang geometry filter may remove those regions during filtering.

FIG. 3B shows an example of interaction between shape and/or topology optimization and application of a build-angle filter. A first shape 360 represents the input to the optimizer for numerical simulation. A second shape 362 represents the first shape 360 after the optimizer update removes material from region 364 in an overhanging region of the modeled object. Then, the build angle filter removes material 366 (in order to return the design to a self-supporting shape) that the optimizer did not “expect” to be affected by the advection performed using the velocity field generated from the numerical simulation.

To address this, a velocity filter can be used to increase the “importance” (from the perspective of the optimizer's shape update process) of material in overhanging regions based on the importance of the material that overhanging-region material is supporting. In level-set shape and/or topology optimization, velocity is assigned by the optimizer at every point on the surface based on the importance of retaining, enlarging, or shrinking a particular region. The optimizer selects this importance based on the derivative of the objective function (and optionally constraints). Thus, the importance of a region that supports overhangs can be artificially increased by increasing its velocity (where larger velocity is more outward movement, i.e., growing, and negative velocity is more inward movement, i.e., shrinking).

The amount of velocity increase should depend directly on the importance of the material which each voxel supports. Thus, the velocity filter can propagate velocity downward in nearly-overhanging regions in such a way that each voxel's velocity is at least as great (i.e., at least as outward) as that of the surface voxels above that voxel which are supported by that voxel. For example, the velocity filter can traverse the ordered set of voxels from top to bottom (furthest from the build plate to closest to the build plate), and perform the following procedure for each voxel. FIG. 3C shows an example of a process of velocity filtering.

For a next voxel, the process determines 380 whether this is an overhanging region. For example, a voxel can be determined to be part of an overhanging region by sampling the signed distance field a distance d (e.g., one voxel) above the current voxel along the build direction. FIG. 3D shows a schematic representation 390 for a velocity filter update. The current voxel is x, and x′ is the sampled point of the signed distance field. The value of the signed distance field at x′ is compared with the signed distance field value of the current voxel, x. If the difference between the current and the offset signed distance field value is greater than a threshold, the voxel is overhanging. In some implementations, a threshold of d sin (0-8°) is used, which corresponds to regions with overhang angles up to 8 degrees less than the critical overhang angle. Angles other than 8 degrees can also be used.

If the voxel is not an overhanging voxel, the velocity field is not changed for that voxel, and the process then makes the determination 380 for a next voxel. If the voxel is an overhanging voxel, the signed distance field is sampled 382 along a circle (circle C in FIG. 3D, where the circle C is orthogonal to the line x-x′ and so is technically in a plane coming out of the drawing sheet, but is shown as an ellipse for ease of understanding) positioned above the current voxel along the build direction 392 (centered at x′) with radius c (with c=d sin 0), searching for a point, e.g., x*, which has a signed distance field value most similar to that at the current voxel x (an “isosurface point”; for sufficiently small error, these two points will lie on the same isosurface, even if it is not the zero isosurface which represents the shape).

If an isosurface point is not found, the velocity field is not changed for that voxel, and the process then makes the determination 380 for a next voxel. If an isosurface point is found for the current voxel, then the velocity field of the isosurface point is sampled 384 to determine the velocity at point x*, i.e., v (x*), and the velocity associated with the current voxel x is updated to be the larger of its current value and the sampled value, according to v (x)←max (v (x), v (x*)). In other words, the velocity field values are propagated in a direction opposite the build direction in a manner that ensures the velocity in a given region of the design cannot be less than the velocity in another region of the design that is supported by the given region. Note that the “larger” and “less than” above are switched to be “smaller” and “greater than” in the event that the meaning of the signed values of the signed distance field are flipped.

If the geometry does not pass the overhang test at 380, e.g., it is not overhanging more than 8 degrees less than the critical overhang angle, then velocity propagation should not happen, since removal of this material will not cause any other geometry to be eliminated by the geometry filter. If no point on the circle at 382 has a signed distance field value nearly equal to that of the current voxel, then either, the signed distance field is changing rapidly (e.g., near where two overhanging faces come together) or a severe overhang is present at this point and the build-angle filter is already going to add or remove material in this region independent of any decision the optimizer makes. Note that the velocity filter is not required for the build-angle filter to be an effective tool in realizing plausibly self-supporting structures. Nonetheless, use of a velocity filter, as described, can improve the computational performance of shape and/or topology optimization using the build-angle filter (reducing the amount of processing resources needed to reach convergence for the shape) and also improve the quality of the output shape (improving the manufacturability of the physical structure represented by that output shape). Moreover, in some implementations, the velocity filter is selectively applied only in regions that are plausibly self-supporting, i.e., don't worry about using the velocity filter in region(s) of the design where overhangs will not be removed. For example, a supportable region can be computed (or saved from the previous iteration's geometry filter and the be reused), and this supportable region can be used as an additional condition in the determination 380, i.e., “Next voxel is in the supportable region and overhanging?”

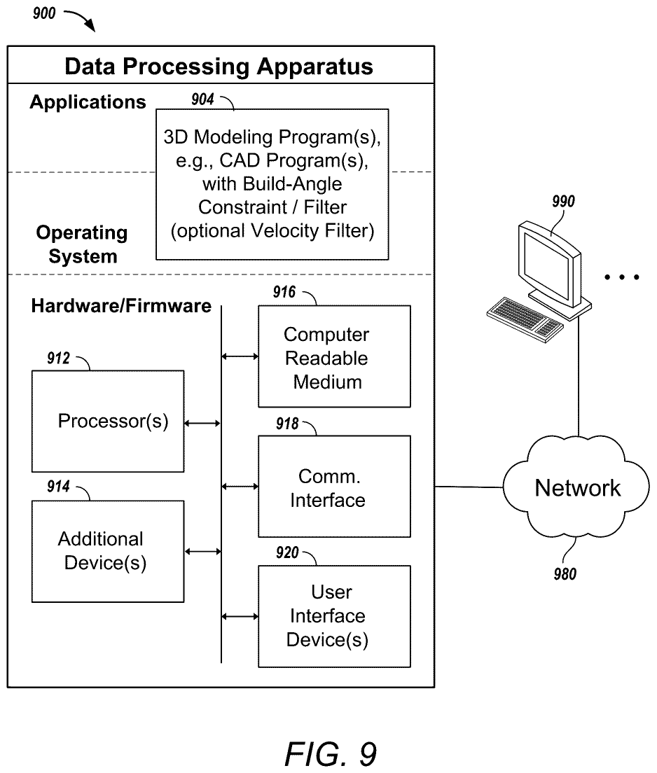

FIG. 9 is a schematic diagram of a data processing system including a data processing apparatus 900, which can be programmed as a client or as a server. The data processing apparatus 900 is connected with one or more computers 990 through a network 980. While only one computer is shown in FIG. 9 as the data processing apparatus 900, multiple computers can be used. The data processing apparatus 900 includes various software modules, which can be distributed between an applications layer and an operating system. These can include executable and/or interpretable software programs or libraries, including tools and services of one or more 3D modeling programs 904 that implement the build-angle filtering (and optionally the velocity filtering) processes described. Thus, the 3D modeling program(s) 904 can be CAD program(s) 904 (such as CAD program(s) 116) and can implement one or more shape synthesis processes (e.g., using level-set based method(s) for generative design) for shape and/or topology optimization and physical simulation operations (finite element analysis (FEA) or other) that incorporate the use of a build-angle constraint/filter, and optionally, velocity filtering.

In some implementations, the output model is not fully self-supporting, but rather is made as self-supporting as is desirable in view of the other objective(s) of the shape synthesis process. Thus, in the case of additive extrusion or deposition manufacturing, some external support structure may need to be produced for the output model in order to complete the manufacturing of the physical structure. However, in some implementations, the output model is required to be fully self-supporting (not accounting for cases in which one or more obstacles are present in configurations that make self-supporting geometries for the modeled object difficult or impossible to achieve). To make fully self-supporting designs, the initial shape should contact the build plate fully, the identification of the self-supportable region is done differently, and the velocity filter (if used) is changed to avoid creating cusps around preserves, as now described.

To ensure that the input shape contains no overhangs (and thus contacts the build plate fully), the shape can be pre-filtered before the optimization loop begins such that the initial shape is extruded downward everywhere to the build plate. This can be done using a variety of approaches. One approach is to pre-filter the geometry with the geometry filter, but with c=0. This causes each voxel to be at least as interior as the voxel above (i.e., an overhang of 90 degrees is enforced).

Further, for a fully self-supported design, only those regions of the design that are in contact with the build plate can be allowed to lack support from the modeled object itself (since those regions have support from the build plate during manufacturing). Thus, the self-supportable region identification algorithm described above can be replaced with a half-space at the build plate location. Further, if the build plate is allowed to move up and down along the build direction during optimization, an additional filter can be added that detects the build plate moving downwards and extends geometry that was previously in contact with the build plate to touch the updated build plate location.

These changes cause the build-angle filter to produce self-supporting designs everywhere except (potentially) directly under some preserve features. To address this, a search/pathfinding can be performed from the cusp regions down to the build plate with restrictions to ensure the path can't take an overhanging trajectory, then the velocity can be frozen everywhere along the path to avoid removing support. Other approaches are possible. Thus, in fully self-supported design implementations, the described algorithm can ensure that all supportable preserve faces are made fully self-supporting, even in places where the cusps applied to preserves might otherwise create a line of geometry needing external supports. Thus, all regions of the shape being synthesized that would violate a critical overhang angle for manufacturing can be made fully-self supporting, thereby satisfying the critical overhang angle throughout the modeled object.

Further, the program(s) 904 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 900 also includes hardware or firmware devices including one or more processors 912, one or more additional devices 914, a computer readable medium 916, a communication interface 918, and one or more user interface devices 920. Each processor 912 is capable of processing instructions for execution within the data processing apparatus 900. In some implementations, the processor 912 is a single or multi-threaded processor. Each processor 912 is capable of processing instructions stored on the computer readable medium 916 or on a storage device such as one of the additional devices 914. The data processing apparatus 900 uses the communication interface 918 to communicate with one or more computers 990, for example, over the network 980. Examples of user interface devices 920 include a display, a camera, a speaker, a microphone, a tactile feedback device, a keyboard, a mouse, and VR and/or AR equipment. The data processing apparatus 900 can store instructions that implement operations associated with the program(s) described above, for example, on the computer readable medium 916 or one or more additional devices 914, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
obtaining, by a shape modeling computer program, a build angle, a manufacturing direction, a design space for a modeled object, for which a corresponding physical structure is to be manufactured using an additive manufacturing process, and one or more design criteria for the modeled object for use in a shape synthesis process to be performed by the shape modeling computer program, wherein the build angle and the manufacturing direction are for the additive manufacturing process;
performing the shape synthesis process, by the shape modeling computer program, comprising iteratively varying a boundary-based computer-data representation of a three-dimensional shape of the modeled object in the design space in accordance with the one or more design criteria to modify the three-dimensional shape of the modeled object, wherein the iteratively varying comprises applying a build-angle filter to the boundary-based computer-data representation of an intermediate version of the three-dimensional shape of the modeled object during multiple iterations of the iteratively varying, and applying the build-angle filter comprises removing a portion of material from the intermediate version of the three-dimensional shape in accordance with the build angle and the manufacturing direction to make the intermediate version of the three-dimensional shape self-supporting in a vicinity of the portion of material, which is removed, the portion of material removed (i) being not self-supported in the intermediate version of the three-dimensional shape and (ii) being located within a three-dimensional region of the design space identified as capable of being self-supported by the intermediate version of the three-dimensional shape; and
providing, by the shape modeling computer program, the three-dimensional shape of the modeled object for use in manufacturing the physical structure using one or more computer-controlled manufacturing systems that use the additive manufacturing process.

2. The method of claim 1, wherein the boundary-based computer-data representation comprises a level-set computer-data representation, and applying the build-angle filter comprises adding material to the intermediate version of the three-dimensional shape in accordance with the build angle and the manufacturing direction to increase self-supportability of the intermediate version of the three-dimensional shape outside of the three-dimensional region of the design space identified as capable of being self-supported by the intermediate version of the three-dimensional shape.

3. The method of claim 2, wherein the adding comprises applying a geometry filter to the level-set computer-data representation of the intermediate version of the three-dimensional shape in a direction opposite to the manufacturing direction, the geometry filter adds material to increase self-supportability based on the build angle and the manufacturing direction, and applying the build-angle filter comprises applying the geometry filter to the level-set computer-data representation of the intermediate version of the three-dimensional shape in the manufacturing direction to identify the three-dimensional region of the design space that is capable of being self-supported by the intermediate version of the three-dimensional shape.

4. The method of claim 2, wherein applying the build-angle filter comprises:
applying a first geometry filter to the level-set computer-data representation of the intermediate version of the three-dimensional shape in the manufacturing direction to identify the three-dimensional region of the design space as capable of being self-supported by the intermediate version of the three-dimensional shape;
inverting the three-dimensional region of the design space to form a non-self-supportable region of the design space;
forming a union level-set computer-data representation of the non-self-supportable region combined with the intermediate version of the three-dimensional shape;
applying a second geometry filter to the union level-set computer-data representation to form a reduced material level-set computer-data representation; and
intersecting the level-set computer-data representation of the intermediate version of the three-dimensional shape with the reduced material level-set computer-data representation to cause removal of the portion of material from the level-set computer-data representation of the intermediate version of the three-dimensional shape.

5. The method of claim 4, wherein applying the build-angle filter comprises selectively growing the reduced material level-set computer-data representation before intersecting the reduced material level-set computer-data representation with the level-set computer-data representation of the intermediate version of the three-dimensional shape.

6. The method of claim 2, wherein applying the build-angle filter comprises:
applying a first geometry filter to the level-set computer-data representation of the intermediate version of the three-dimensional shape in the manufacturing direction to identify the three-dimensional region of the design space as capable of being self-supported by the intermediate version of the three-dimensional shape; and
applying a second geometry filter to the level-set computer-data representation of the intermediate version of the three-dimensional shape, only within the three-dimensional region of the design space, to remove the portion of material from the level-set computer-data representation of the intermediate version of the three-dimensional shape.

7. The method of claim 2, wherein applying the build-angle filter comprises:
applying a geometry filter to a level-set computer-data representation of all portions of the design space that are both (i) exterior to the intermediate version of the three-dimensional shape and (ii) within the three-dimensional region of the design space identified as capable of being self-supported by the intermediate version of the three-dimensional shape, thereby forming a void body; and
subtracting the void body from the level-set computer-data representation of the intermediate version of the three-dimensional shape to remove the portion of material from the level-set computer-data representation of the intermediate version of the three-dimensional shape.

8. The method of claim 7, wherein applying the build-angle filter comprises selectively shrinking the void body before subtracting the void body from the intermediate version of the three-dimensional shape.

9. The method of claim 2, wherein the obtaining comprises obtaining a level-set computer-data representation one or more preserve bodies, the method comprises applying a geometry filter to the level-set computer-data representation the one or more preserve bodies in a direction opposite to the manufacturing direction, thereby forming an enlarged version of the one or more preserve bodies, and performing the shape synthesis process comprises:
using the enlarged version of the one or more preserve bodies as input to the shape synthesis process; and
optionally, preventing insertion of bubbles inside the enlarged version of the one or more preserve bodies during the iteratively varying.

10. The method of claim 2, wherein the iteratively modifying comprises:
modifying a numerical assessment of the intermediate version of the three-dimensional shape, the numerical assessment having been produced by numerical simulation of the modeled object in accordance with the one or more design criteria, by changing values of the numerical assessment in a first region based on values of the numerical assessment in a second region that is supported by the first region in accordance with the build angle, thereby forming a modified numerical assessment; and
updating the intermediate version of the three-dimensional shape based on the modified numerical assessment to produce an updated version of the three-dimensional shape.

11. The method of claim 2, wherein the level-set computer-data representation comprises a data structure comprising discrete elements holding data values indicating distances to an implicit surface of the three-dimensional shape of the modeled object, applying the build-angle filter comprises applying a geometry filter to the level-set computer-data representation of the intermediate version of the three-dimensional shape in the manufacturing direction to identify the three-dimensional region of the design space as capable of being self-supported by the intermediate version of the three-dimensional shape, and the geometry filter operates in three dimensions and changes a current value of a discrete element indicating a distance to the implicit surface based on a comparison of the current value with an other value and a constant value, the other value being determined from one or more values found in one or more other discrete elements in the data structure located away from the discrete element along the manufacturing direction, and the constant value being determined for the build angle.

12. The method of claim 2, wherein applying the build-angle filter comprises applying a geometry filter to cause removal of the portion of material from the level-set computer-data representation of the intermediate version of the three-dimensional shape, and the geometry filter extracts a two dimensional profile from a first discrete layer of an input three-dimensional shape, offsets the two-dimensional profile in accordance with the build angle to form an offset two-dimensional profile, and changes a second discrete layer of the input three-dimensional shape using offset two-dimensional profile.

13. The method of claim 2, wherein the providing comprises:
using the three-dimensional shape of the modeled object to generate toolpath specifications for the one or more computer-controlled manufacturing systems; and
manufacturing (i) at least a portion of the physical structure with the one or more computer-controlled manufacturing systems using the toolpath specifications, (ii) at least a portion of a mold for the physical structure with the one or more computer-controlled manufacturing systems using the toolpath specifications, wherein the portion of the mold is a negative of a portion of the physical structure, or (iii) at least a portion of a doppelganger of the physical structure with the one or more computer-controlled manufacturing systems using the toolpath specifications, wherein the at least a portion of the doppelganger of the physical structure is usable to form at least a portion of a mold for the physical structure.

14. A system comprising:
a non-transitory storage medium having instructions of a shape modeling computer program stored thereon; and
one or more data processing apparatus configured to run the instructions of the shape modeling computer program to cause the one or more data processing apparatus to perform operations comprising:
obtaining a build angle, a manufacturing direction, a design space for a modeled object, for which a corresponding physical structure is to be manufactured using an additive manufacturing process, and one or more design criteria for the modeled object for use in a shape synthesis process to be performed by the shape modeling computer program, wherein the build angle and the manufacturing direction are for the additive manufacturing process;
performing the shape synthesis process comprising iteratively varying a boundary-based computer-data representation of a three-dimensional shape of the modeled object in the design space in accordance with the one or more design criteria to modify the three-dimensional shape of the modeled object, wherein the iteratively varying comprises applying a build-angle filter to the boundary-based computer-data representation of an intermediate version of the three-dimensional shape of the modeled object during multiple iterations of the iteratively varying, and applying the build-angle filter comprises removing a portion of material from the intermediate version of the three-dimensional shape in accordance with the build angle and the manufacturing direction to make the intermediate version of the three-dimensional shape self-supporting in a vicinity of the portion of material, which is removed, the portion of material removed (i) being not self-supported in the intermediate version of the three-dimensional shape and (ii) being located within a three-dimensional region of the design space identified as capable of being self-supported by the intermediate version of the three-dimensional shape; and
providing the three-dimensional shape of the modeled object for use in manufacturing the physical structure using one or more computer-controlled manufacturing systems that use the additive manufacturing process.

15. The system of claim 14, wherein the boundary-based computer-data representation comprises a level-set computer-data representation, and applying the build-angle filter comprises adding material to the intermediate version of the three-dimensional shape in accordance with the build angle and the manufacturing direction to increase self-supportability of the intermediate version of the three-dimensional shape outside of the three-dimensional region of the design space identified as capable of being self-supported by the intermediate version of the three-dimensional shape.

16. The system of claim 15, wherein the adding comprises applying a geometry filter to the level-set computer-data representation of the intermediate version of the three-dimensional shape in a direction opposite to the manufacturing direction, the geometry filter adds material to increase self-supportability based on the build angle and the manufacturing direction, and applying the build-angle filter comprises applying the geometry filter to the level-set computer-data representation of the intermediate version of the three-dimensional shape in the manufacturing direction to identify the three-dimensional region of the design space that is capable of being self-supported by the intermediate version of the three-dimensional shape.

17. The system of claim 15, wherein applying the build-angle filter comprises:
applying a first geometry filter to the level-set computer-data representation of the intermediate version of the three-dimensional shape in the manufacturing direction to identify the three-dimensional region of the design space as capable of being self-supported by the intermediate version of the three-dimensional shape;
inverting the three-dimensional region of the design space to form a non-self-supportable region of the design space;
forming a union level-set computer-data representation of the non-self-supportable region combined with the intermediate version of the three-dimensional shape;
applying a second geometry filter to the union level-set computer-data representation to form a reduced material level-set computer-data representation; and
intersecting the level-set computer-data representation of the intermediate version of the three-dimensional shape with the reduced material level-set computer-data representation to cause removal of the portion of material from the level-set computer-data representation of the intermediate version of the three-dimensional shape.

18. The system of claim 15, wherein applying the build-angle filter comprises:
applying a first geometry filter to the level-set computer-data representation of the intermediate version of the three-dimensional shape in the manufacturing direction to identify the three-dimensional region of the design space as capable of being self-supported by the intermediate version of the three-dimensional shape; and
applying a second geometry filter to the level-set computer-data representation of the intermediate version of the three-dimensional shape, only within the three-dimensional region of the design space, to remove the portion of material from the level-set computer-data representation of the intermediate version of the three-dimensional shape.

19. The system of claim 15, wherein the iteratively modifying comprises:
modifying a numerical assessment of the intermediate version of the three-dimensional shape, the numerical assessment having been produced by numerical simulation of the modeled object in accordance with the one or more design criteria, by changing values of the numerical assessment in a first region based on values of the numerical assessment in a second region that is supported by the first region in accordance with the build angle, thereby forming a modified numerical assessment; and
updating the intermediate version of the three-dimensional shape based on the modified numerical assessment to produce an updated version of the three-dimensional shape.

20. The system of claim 15, wherein the level-set computer-data representation comprises a data structure comprising discrete elements holding data values indicating distances to an implicit surface of the three-dimensional shape of the modeled object, applying the build-angle filter comprises applying a geometry filter to the level-set computer-data representation of the intermediate version of the three-dimensional shape in the manufacturing direction to identify the three-dimensional region of the design space as capable of being self-supported by the intermediate version of the three-dimensional shape, and the geometry filter operates in three dimensions and changes a current value of a discrete element indicating a distance to the implicit surface based on a comparison of the current value with an other value and a constant value, the other value being determined from one or more values found in one or more other discrete elements in the data structure located away from the discrete element along the manufacturing direction, and the constant value being determined for the build angle.

21. A non-transitory computer-readable medium tangibly encoding a computer program operable to cause data processing apparatus to perform operations comprising:
obtaining a build angle, a manufacturing direction, a design space for a modeled object, for which a corresponding physical structure is to be manufactured using an additive manufacturing process, and one or more design criteria for the modeled object for use in a shape synthesis process to be performed by the shape modeling computer program, wherein the build angle and the manufacturing direction are for the additive manufacturing process;
performing the shape synthesis process comprising iteratively varying a boundary-based computer-data representation of a three-dimensional shape of the modeled object in the design space in accordance with the one or more design criteria to modify the three-dimensional shape of the modeled object, wherein the iteratively varying comprises applying a build-angle filter to the boundary-based computer-data representation of an intermediate version of the three-dimensional shape of the modeled object during multiple iterations of the iteratively varying, and applying the build-angle filter comprises removing a portion of material from the intermediate version of the three-dimensional shape in accordance with the build angle and the manufacturing direction to make the intermediate version of the three-dimensional shape self-supporting in a vicinity of the portion of material, which is removed, the portion of material removed (i) being not self-supported in the intermediate version of the three-dimensional shape and (ii) being located within a three-dimensional region of the design space identified as capable of being self-supported by the intermediate version of the three-dimensional shape; and
providing the three-dimensional shape of the modeled object for use in manufacturing the physical structure using one or more computer-controlled manufacturing systems that use the additive manufacturing process.

22. The non-transitory computer-readable medium of claim 21, wherein the boundary-based computer-data representation comprises a level-set computer-data representation, and applying the build-angle filter comprises adding material to the intermediate version of the three-dimensional shape in accordance with the build angle and the manufacturing direction to increase self-supportability of the intermediate version of the three-dimensional shape outside of the three-dimensional region of the design space identified as capable of being self-supported by the intermediate version of the three-dimensional shape.

23. The non-transitory computer-readable medium of claim 22, wherein the adding comprises applying a geometry filter to the level-set computer-data representation of the intermediate version of the three-dimensional shape in a direction opposite to the manufacturing direction, the geometry filter adds material to increase self-supportability based on the build angle and the manufacturing direction, and applying the build-angle filter comprises applying the geometry filter to the level-set computer-data representation of the intermediate version of the three-dimensional shape in the manufacturing direction to identify the three-dimensional region of the design space that is capable of being self-supported by the intermediate version of the three-dimensional shape.

24. The non-transitory computer-readable medium of claim 22, wherein applying the build-angle filter comprises:
applying a first geometry filter to the level-set computer-data representation of the intermediate version of the three-dimensional shape in the manufacturing direction to identify the three-dimensional region of the design space as capable of being self-supported by the intermediate version of the three-dimensional shape;
inverting the three-dimensional region of the design space to form a non-self-supportable region of the design space;
forming a union level-set computer-data representation of the non-self-supportable region combined with the intermediate version of the three-dimensional shape;
applying a second geometry filter to the union level-set computer-data representation to form a reduced material level-set computer-data representation; and
intersecting the level-set computer-data representation of the intermediate version of the three-dimensional shape with the reduced material level-set computer-data representation to cause removal of the portion of material from the level-set computer-data representation of the intermediate version of the three-dimensional shape.

25. The non-transitory computer-readable medium of claim 22, wherein applying the build-angle filter comprises:
applying a geometry filter to a level-set computer-data representation of all portions of the design space that are both (i) exterior to the intermediate version of the three-dimensional shape and (ii) within the three-dimensional region of the design space identified as capable of being self-supported by the intermediate version of the three-dimensional shape, thereby forming a void body; and
subtracting the void body from the level-set computer-data representation of the intermediate version of the three-dimensional shape to remove the portion of material from the level-set computer-data representation of the intermediate version of the three-dimensional shape.

26. The non-transitory computer-readable medium of claim 22, wherein the obtaining comprises obtaining a level-set computer-data representation one or more preserve bodies, the operations comprise applying a geometry filter to the level-set computer-data representation the one or more preserve bodies in a direction opposite to the manufacturing direction, thereby forming an enlarged version of the one or more preserve bodies, and performing the shape synthesis process comprises:
using the enlarged version of the one or more preserve bodies as input to the shape synthesis process; and
optionally, preventing insertion of bubbles inside the enlarged version of the one or more preserve bodies during the iteratively varying.

27. The non-transitory computer-readable medium of claim 22, wherein applying the build-angle filter comprises applying a geometry filter to cause removal of the portion of material from the level-set computer-data representation of the intermediate version of the three-dimensional shape, and the geometry filter extracts a two dimensional profile from a first discrete layer of an input three-dimensional shape, offsets the two-dimensional profile in accordance with the build angle to form an offset two-dimensional profile, and changes a second discrete layer of the input three-dimensional shape using offset two-dimensional profile.
